(19) United States
(12) Patent Application Publication
(10) Pub. No.: US 2024/0029511 A1
(43) Pub. Date: Jan. 25, 2024

(54) INFORMATION PROCESSING APPARATUS, INFORMATION PROCESSING METHOD, AND SYSTEM

(71) Applicant: MIXI, INC., Tokyo (JP)

(72) Inventor: Hirotake TERUUCHI, Tokyo (JP)

(21) Appl. No.: 18/478,513

(22) Filed: Sep. 29, 2023

Related U.S. Application Data
(63) Continuation-in-part of application No. PCT/JP2022/010030, filed on Mar. 8, 2022.

(30) Foreign Application Priority Data
Mar. 30, 2021 (JP) 2021-057652

(51) Int. Cl. G07F 17/32

(52) U.S. Cl. CPC G07F 17/3244; G07F 17/3274; G07F 17/323; G07F 17/3288; G07F 17/3269; G07F 17/3211; G07F 17/3209

(57) ABSTRACT

The present invention improves the motivation for a plurality of players to form groups and cast votes. A server 10 that receives votes for the results of a game comprises: a registration unit 111 that registers a plurality of players, which include first players and second players, as groups; a reception unit 102 that receives, with respect to the game, first vote information made by the first players and second vote information made by the second players; and a reward granting unit 104 that grants, to the first players, a first reward determined on the basis of the first vote information.

This continuation-in-part application claims priority under 35 U.S.C. 120 and § 365 to PCT Application No. PCT/JP2022/010030, filed on Mar. 8, 2022, which claims priority to Japanese Application No. 2021-057652, filed on Mar. 30, 3021, the content of which is incorporated herein in its entirety for all purposes.

### TECHNICAL FIELD

The present disclosure relates to an information processing apparatus, an information processing method, and a system.

### BACKGROUND ART

For example, in various games to be bet, such as horse race, bicycle race, and boat race, a betting device receives betting from bettors is used (refer to, for example, Patent Literature 1 (JP2013-114487A)). The bettor can bet by writing, on a betting sheet, betting matters required for betting, and inputting the betting matters into the betting device. For example, in a horse race, matters such as a race site where the race is held, the betting method such as permutation betting or combination betting, and names of horses to be betted are written on the betting sheet and input to the betting device, and thus, the betting can be performed.

### CITATION LIST

### Patent Literature

Patent Literature 1: JP2013-114487A

### SUMMARY OF INVENTION

### Technical Problem

However, the betting method used in the above-mentioned game is complicated, and basically, a contestant or a horse to be betted is determined by one bettor to perform the betting.

An object of the present disclosure is to provide technology capable of improving motivation of a plurality of players to form a group and bet.

### Solution to Problem

An information processing apparatus according to an aspect of the present disclosure is an information processing apparatus receiving bets for a game, the apparatus including a processor, in which the processor: registers a plurality of players including a first player and a second player as a group; receives first betting information indicating that the first player bets and second betting information indicating that the second player bets for the game; assigns a first benefit determined based on the first betting information to the first player; assigns the first benefit to the second player when the second betting information satisfies a predetermined condition.

According to one aspect of the present disclosure, it is possible to improve motivation of the plurality of players to form the group and bet.

### BRIEF DESCRIPTION OF DRAWINGS

FIG. 1 is a diagram illustrating an example of a system configuration of a betting system according to a first embodiment.

FIG. 2 is a diagram illustrating a hardware configuration example of a server and a terminal.

FIG. 3 is a diagram illustrating a functional block configuration example of the server.

FIG. 4 is a diagram illustrating an example of a player management DB and a team management DB.

FIG. 5 illustrates an example of a screen displaying a benefit assigned to the player.

FIGS. 6A and 6B are tables illustrating an example of a method of calculating a benefit assigned to the player.

FIG. 7 is a flowchart illustrating an example of a process procedure performed by the betting system.

FIG. 8 is a flowchart illustrating an example of a process procedure performed by the betting system.

FIG. 9 is a diagram illustrating a functional block configuration example of a server according to a second embodiment.

FIG. 10 is a diagram illustrating an example of benefit grade information.

FIG. 11 is a diagram illustrating an example of a benefit assigned to the player joining the group.

FIG. 12 is a sequence diagram illustrating an example of a process procedure performed by a betting system according to the second embodiment.

FIG. 13 is a sequence diagram illustrating an example of a process procedure performed by the betting system according to the second embodiment.

FIG. 14 is a diagram illustrating an example of a betting screen.

FIG. 15 is a diagram illustrating an example of a recruitment screen.

FIG. 16 is a diagram illustrating an example of a join request screen.

FIG. 17 is a diagram illustrating an example of a team play screen.

FIG. 18 is a diagram illustrating an example of a purchased betting ticket details screen.

FIG. 19 is a diagram illustrating an example of a team play screen.

FIG. 20 is a diagram illustrating an example of a benefit assignment screen.

### DESCRIPTION OF EMBODIMENTS

### First Embodiment

Embodiments of the present disclosure will be described with reference to the accompanying drawings. Note that, in each drawing, the same or similar configurations are denoted by the same reference numerals.

<1. System Configuration>

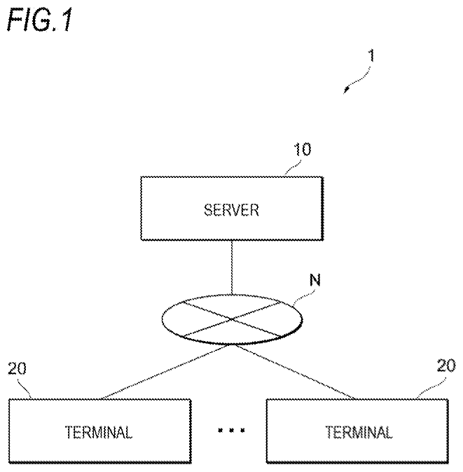

FIG. 1 is the diagram illustrating an example of a system configuration of a betting system 1 according to an embodiment. The betting system 1 illustrated in FIG. 1 includes a server 10 and one or more terminals 20. The server 10 and the terminal 20 are communicably connected to each other via a communication network N such as the Internet, intranet, wireless LAN, or mobile communication. The server 10 and the terminal 20 may be referred to as an information processing apparatus.

The server 10 may be configured from one or a plurality of physical servers or the like, may be configured using a virtual server operating on a hypervisor, or may be configured using a cloud server. The terminal 20 is a terminal used by a player who is a user of the betting system 1, and the player can bet on the betting target by operating the terminal 20. The terminal 20 is, for example, a mobile phone (including a smart phone), a tablet terminal, a personal computer, or the like.

For example, in a game in which the betting is performed, the server 10 manages the betting targets betted by the players, manages predetermined values owned by the players, and manages refund amounts (for example, refund money, or the like) according to a result of the game. Herein, the “game” denotes, for example, a race such as a bicycle race, a horse race, a boat race, or a car race, however it is not limited to those listed here and may include any type of competitions or games including sports. The server 10 and the terminal 20 may receive bets for each game in which bets are available for the betting target.

The “betting target” denotes a target betted for the predetermined value and is uniquely defined by combining designation of a contestant who is predicted to win among contestants (including athletes and animals) joining the game and designation of a betting method. Specifically, in a bicycle race, there are a perfecta designating fifth and third runners as first and second arrivers respectively, a trio designating the first, second, and fifth runners, and the like. Note that the perfecta is a bet predicting the first and second arrivers in the order of arrivals, and the trio is a bet predicting the first to third arrivers (however, the order of arrivals does not matter). In a horse race, there are a win, a fifth place, and the like.

The “predetermined value” may be, for example, money or may be a point that can be betted on the betting target. Note that the predetermined value is also simply referred to as a “value”. The predetermined value may include, for example, a first value and a second value. The “first value” is a specific value. The “second value” is a specific value different in type from the first value, and for example, when the first value is a monetary unit, the second value may be virtual currency or points.

The point may be available for a predetermined service or game in addition to betting. For example, the point may be exchangeable with items or virtual currency that can be used in the predetermined service or game. The virtual currency is, for example, tokens such as coins that can be obtained for free in the game (hereinafter referred to as “free coins”). The point may be, for example, a point with which the player playing the predetermined service or game can receive for free in the predetermined service or game (hereinafter referred to as a “free point”), and the point may be a point that can be received in exchange for payment of money (for example, by charging) in the predetermined service or game (hereinafter referred to as a “paid point”). The free point may be a point that can be used in a so-called Gacha, in the game in which objects such as characters and items used in online game are obtained by lottery/random drawing.

In the betting system 1, when the betting target betted by the player is hit, that is, when the betting target is a payment target of the reward, the player is assigned with the predetermined reward (for example, the refund) according to the predetermined value betted. The predetermined reward may be the same value as the predetermined value (for example, when the predetermined value is money, the reward is also money or the like) or may be a value different from the predetermined value (for example, when the predetermined value is money, the reward is a point or the like). Note that when the target betted by the player is hit, it is also referred to as “the betting of player is hit”.

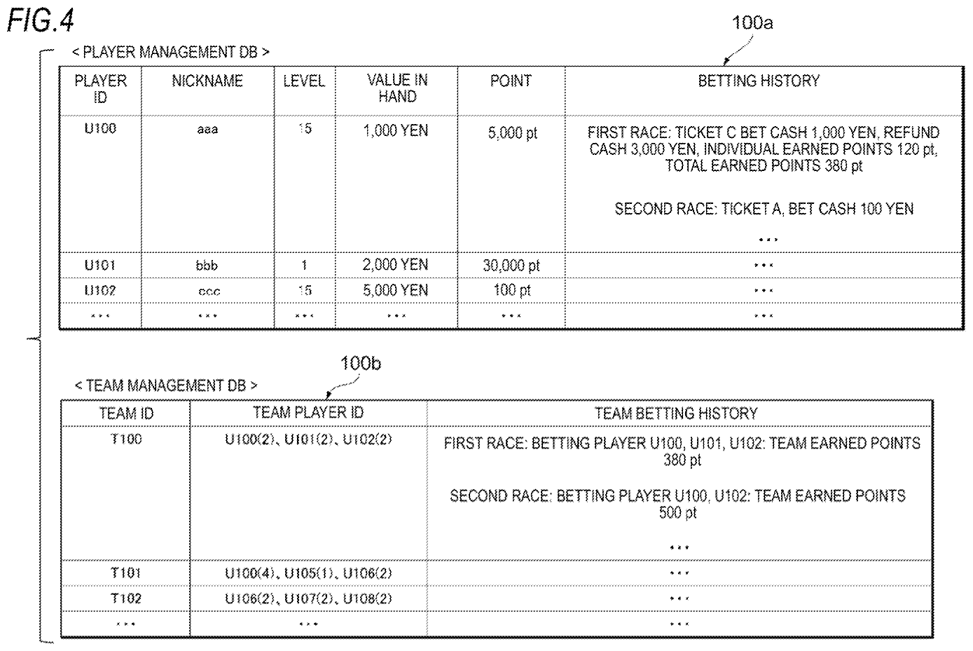

In the betting system 1, players can form teams with other players for a predetermined period or for a game. In the betting system 1, for example, the player may be assigned with the benefit by joining the team formed with other players. Herein, “a player joins the team” specifically denotes that the player is associated with the specific team. For example, as in a team management DB 100b of FIG. 4 described later, a team ID that uniquely identifies each team may be associated with a player ID that uniquely identifies each player. Herein, the “benefit” is something that is assigned to the player in an advantageous manner and may be, for example, a virtual currency, an item that can be used in the game, or a point. The benefit is, for example, the reward paid when the betting of the player is hit. The benefit may be assigned to the player as the supplementary prize (for example, the refund, or the like).

The “predetermined period” is a period during which the team configured with the plurality of players is maintained. For example, the predetermined period may be a period that includes a time zone during which the game is held (for example, one day), may be a period from the designation by the player of forming a new team to the designation of canceling the team, or may be a period from the formation of the new team until all the players in the team disappear due to withdrawal or the like. Herein, “to form a new team” specifically denotes to register information about the new team in the database such as the team management DB 100b in FIG. 4 as the new record.

<2. Hardware Configuration>

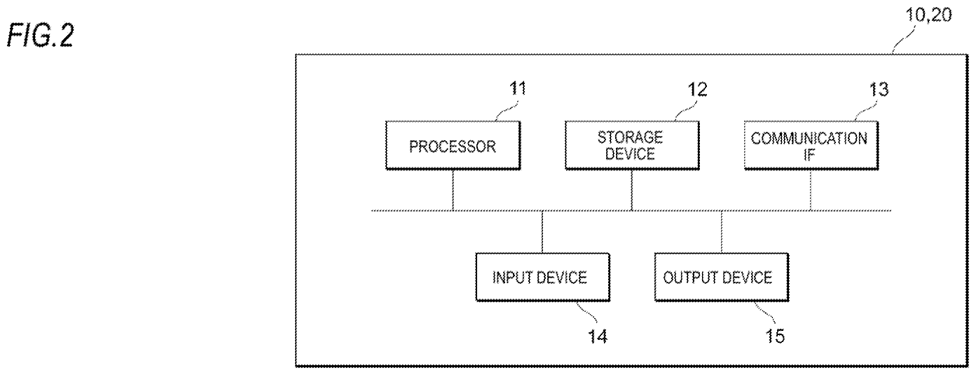

FIG. 2 is a diagram illustrating a hardware configuration example of a server 10 and a terminal 20. The server 10 and the terminal 20 include a processor 11 such as a central processing unit (CPU) and/or a graphical processing unit (GPU), a storage device 12 such as a memory, a hard disk drive (HDD) and/or a solid state drive (SSD), a communication interface (IF) 13 for performing wired or wireless communication, an input device 14 for receiving input operations, and an output device 15 for outputting information. The input device 14 is, for example, a keyboard, a touch panel, a mouse and/or a microphone. The output device 15 is, for example, a display and/or a speaker. As explained below, the hardware is required for the embodiments to operate.

<3. Functional Block Configuration>

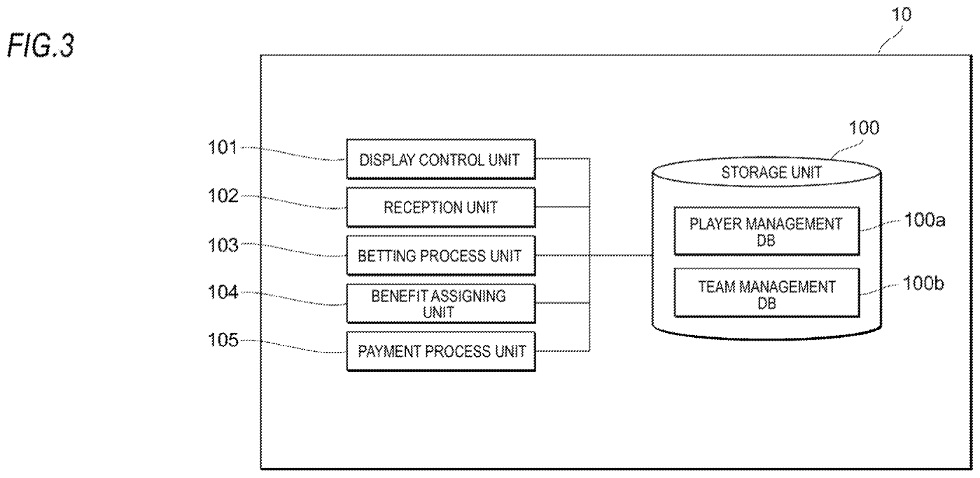

FIG. 3 is a diagram illustrating a functional block configuration example of the server 10. The server 10 includes a storage unit 100, a display control unit 101, a reception unit 102, a benefit assigning unit 104, and a payment process unit 105. The storage unit 100 can be implemented by using the storage device 12 included in the server 10. The display control unit 101, the reception unit 102, the betting process unit 103, the benefit assigning unit 104, and the payment process unit 105 can be implemented by causing the processor 11 of the server 10 to execute the program stored in the storage device 12. The program can be stored in the storage medium. The storage medium storing the program may be a non-transitory computer readable medium. The non-transitory computer readable medium is not particularly limited, but may be, for example, a storage medium such as a USB memory or CD-ROM.

The storage unit 100 stores a player management DB 100a and a team management DB 100b.

<4. Data Structure>

FIG. 4 illustrates an example of the player management DB 100a and the team management DB 100b. An identifier for uniquely identifying the player within the server 10 is stored in a “player ID” of the player management DB 100a. A nickname input by the player at the time of player registration is stored in a “nickname”. An amount of a predetermined value possessed by the player is stored in a “value in hand”. An amount of a point owned by the player is stored in a “point”. In the “point”, an amount of a paid point and an amount of a free point may be stored separately. In a “betting history”, stored are the betting target betted by the player, the predetermined value betted, the reward earned by the player (described as “refund cash” in the present example), the benefit earned by the individual (described as “point” in the present example, and the same applies hereinafter), and the total earned benefit obtained by adding the benefit earned in the team to the benefit earned by the individual for each race.

The identifier for uniquely identifying each team within the server 10 is stored in a “team ID” of the team management DB 100b. The identifier for uniquely identifying the player in each team is stored in a “team player ID”. For example, a flag indicating the join status of each player in association with the identifier (for example, “1: applying to join”, “2: joined”, “3: inviting”, “4: temporary withdrawal”, or the like) may be stored in the “team player ID”. As illustrated in FIG. 4, a player associated with the player ID U100 of team T100 has the status flag “2” indicating that the player has joined the team. In each race, the players (described as “betting players” in the present example) who betted among the players in each team and the benefit (described as a “team earning point” in the present example) assigned to the team players is stored in the “team betting history”.

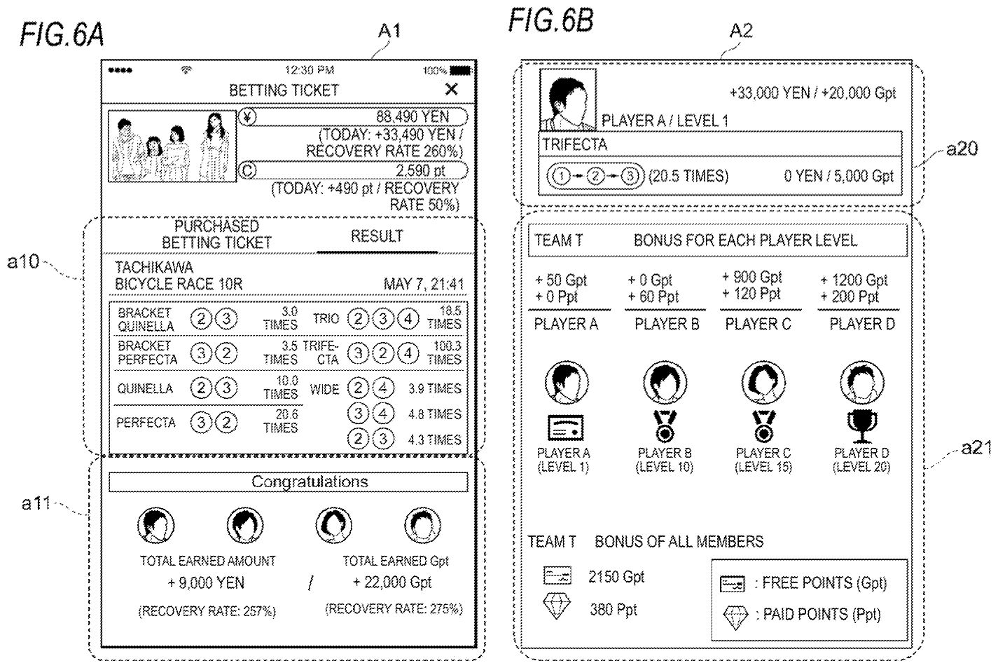

The display control unit 101 performs various processes necessary for allowing the display of the terminal 20 to display the screen for receiving the designation of the betting target from the player, the screen illustrating the amount of the reward or the benefit (for example, betting result screens A1 and A2 illustrated in FIG. 6 to be described later), and the like. The display control unit 101 may be allowed to transmit data for displaying various screens to the terminal 20 in response to access from the web browser provided in the terminal 20 or in response to access from the dedicated application installed in the terminal 20.

The reception unit 102 has a function of receiving the designation of the betting target and the predetermined value from the player. The reception unit 102 may receive the composition of the new team or the designation of the joining of the player in the existing team from a player A. The reception unit 102 may also receive the designation from the player to invite another player to join the specific team. For example, the reception unit 102 may receive the designation via the screen of the terminal 20. When receiving the designation of the above-described invitation, the reception unit 102 may notify other invited players of the invitation through the screen of the terminal 20.

The betting process unit 103 has a function of executing the process of betting with the predetermined value received by the reception unit 102 from the player to the betting target received by the reception unit 102 from the player for each game. Note that the betting process unit 103 may be allowed to bet on the betting target received from the player by accessing the external system that receives betting for the game and pays refund cash.

The benefit assigning unit 104 allows the plurality of players to form the team during a predetermined period or for the game and assigns the benefit to the player when a predetermined condition is satisfied. Herein, the “the predetermined condition” denotes matters to be satisfied by the player to assign the benefit to the player A. The predetermined condition may include, for example, joining of the player in the team and betting on the betting target. For example, when the reception unit 102 receives the designation of the invitation from the player to invite another player to join the team, the benefit assigning unit 104 may assign the benefit to the invited player.

According to the above-described configuration, since the benefit assigning unit 104 assigns the benefit when the player together with another player forms the team and bets, the benefit assigning unit 104 can enhance the motivation (hereinafter, referred to “play motivation”) of the player to bet. According to the above-described configuration, it is possible to encourage the player to induce other players to betting.

The predetermined condition may include, for example, that the player joins the team from the predetermined time when betting on the betting target is receivable until the end of the game. Herein, “until the end of the game” may be, for example, when the game is a bicycle race, until the contestant for whom the target of the race-ticket is issued reaches the finish line. Herein, “until the end of the game” may be, as another example, until the order of finish of the game is confirmed. According to such a configuration, it is possible to prevent the player from withdrawing from the team before the end of the game.

The predetermined condition may include, for example, that the player does not join another team from the predetermined time when the betting on the betting target is receivable until the end of the game. Herein, “the player does not join another team” may include, for example, that the player temporarily withdraws from the team and joins another team.

For example, when the betting targets betted by the other players in the same team as the player (hereinafter also referred to as “other team players”, and all the players joining the specific team are also referred to as “team players”) is the payment target of the reward, that is, when the betting of the other team player is hit, the benefit assigning unit 104 may assign the benefit to the player. According to such a configuration, since the benefit assigning unit 104 assigns incentives to other team players in the same team as the player when the betting of the player is hit, the benefit assigning unit 104 can enhance the play motivation, such as contributing to the other team players in the same team by betting.

For example, when the betting target received by the reception unit 102 from the player is the payment target of the reward, the benefit assigning unit 104 may assign the benefit to the player. According to such a configuration, since the benefit assigning unit 104 can assign the incentive to the player when the betting of the player own is hit, the benefit assigning unit 104 can enhance the play motivation.

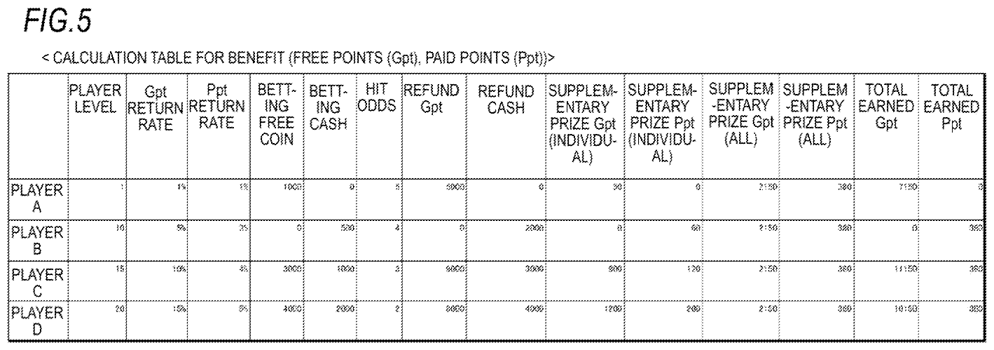

For example, the benefit assigning unit 104 may assign the benefit to the player according to the reward paid to the team player in the same team as the player. The benefit assigning unit 104 may calculate the degree of contribution to the team of the team player to whom the reward is paid (hereinafter simply referred to as “degree of contribution”) based on the reward. The degree of contribution may be set, for example, by dividing the amount of rewards to be paid into the predetermined ranges and setting N levels (N: specific numerical values) such as “high/medium/low” for each divided range. Note that the specific example of calculation of the benefit assigned to the player by the benefit assigning unit 104 will be described later with reference to FIG. 5. According to such a configuration, the benefit assigning unit 104 can enhance the play motivation by such betting to obtain more rewards for the team players in the same team.

The benefit assigning unit 104 may assign the benefit to the player according to the level of one or a plurality of the team players by which the betting target betted is the payment target of the reward among the team players in the same team as the player. Herein, the “level” is an index indicating a degree of utilization of the predetermined service, a degree of progress of the game, and a degree of proficiency in the game. The level may be improved when the predetermined service is used, may be improved as the game progresses, or may be improved as the predetermined condition are satisfied. Specifically, the level may be set according to at least one of the number of times of betting by the player in the predetermined period, the predetermined value betted by the player, and the accumulated reward paid to the player. The benefit assigning unit 104 may calculate a degree of contribution of the team player to the team based on the level of the team player. The degree of contribution may be set for each range by classifying the level of the player into predetermined ranges similarly to the example of the reward to be paid, as described above.

According to the above-described configuration, since the benefit assigning unit 104 assigns the benefit according to the level of the team player of which betting is hit, that is, the experience of betting of the team player, the benefit assigning unit 104 can increase the incentive to the betting. Therefore, according to such a configuration, the benefit assigning unit 104 can enhance the play motivation of such raising the level by betting more.

For example, the benefit assigning unit 104 may assign the benefit to the player according to the highest level among the levels of the team players in the same team as the player. According to such a configuration, the benefit assigning unit 104 can increase the play motivation by allowing the player to have the sense of game with other team players while enhancing the play motivation to bet more to contribute to the team players of the same team and raise the level.

For example, when the player bets with the first value on the betting target, the benefit assigning unit 104 may assign a first benefit according to the team player betting with the first value to the player among team players in the same team as the player. For example, when the player bets on the betting target, the benefit assigning unit 104 may assign the second benefit according to the team player betting with the second value among the team players in the same team as the player. For example, the benefit assigning unit 104 may assign the team players betting with the first values according to the first benefits with the sum of the first benefits assigned to the team players. On the other hand, similarly, the benefit assigning unit 104 may assign the sum of the second benefits to the team players betting with the second value according to the second benefit. According to such a configuration, the benefit assigning unit 104 can provide variations to the benefits assigned to the team players.

When the betting target betted with the predetermined value by the player is the payment target of the reward (in other words, when the betting of the player is hit), the payment process unit 105 has a function of performing payment process for rewarding the player (for example, refund) according to the predetermined value betted by the player by using the server itself or the external system for each game.

The example of the benefit calculation method in the benefit assigning unit 104 will be described with reference to FIG. 5. FIG. 5 is a table for calculating the first benefit and the second benefit assigned to each team player in the team in the specific race (hereinafter referred to as “n-th race”). In the present example, the predetermined value includes the first value and the second value, and the first value is free coins and the second value is a cash. In the present example, the first benefit according to the first value is the free point (hereinafter also referred to as a “Gpt (Gacha Point)”), and the second benefit according to the second value is the paid point (hereinafter referred to as a “Ppt (“Product Point”)”. Note that, in this example, to simplify the explanation, it is assumed that the bets of all team players in the team are hit.

First, for each team player, a Gpt return rate and a Ppt return rate are set according to each level. For example, to a player A, the Gpt return rate is set to “1(%)” and the Ppt return rate is set to “1(%)” according to the level “1” of the player A. On the other hand, to a player D, the Gpt return rate is set to “15(%)” and the Ppt return rate is set to “5(%)” according to the level “20” of the player D.

Next, by the betting process unit 103, each team player bets on the betting targets, each of which designated the amount of the free coin (bet free coin) and/or the cash (bet cash) amount designated by each in the n-th race.

Next, when the betting of the team player own is hit in the n-th race, by the payment process unit 105, each team player is paid the reward (refund free point (refund Gpt) and/or the refund cash) based on the predetermined betted value (free coin and/or cash) and the odds (hit odds). Herein, “odds” indicates the odds of receiving the refund when the race-ticket of the bicycle race wins. For example, the payment process unit 105 pays the player A the free point “5000 (Gpt)” obtained by multiplying the betted free coin “1000 (coin)” by the odds “5”. For example, a player C is paid the free point “9000 (Gpt)” obtained by multiplying the betted free coin “3000 (coin)” by the odds “3” and is paid the cash “3000 yen” obtained by multiplying the betted cash “1000 (yen)” by the odds “3”.

The benefit assigning unit 104 calculates the benefit of the player individual based on the reward paid in the n-th race for each team player. For example, the benefit assigning unit 104 calculates the free point “50 (Gpt)” obtained by multiplying the free point “5000 (Gpt)” to be paid as the first benefit (supplementary prize Gpt (individual)) by the Gpt return rate “1(%)” for the player A. For example, the benefit assigning unit 104 calculates the free point “900 (Gpt)” of the value obtained by multiplying the free point “9000 (Gpt)” of the first value to be paid as the first benefit (supplementary prize Gpt (individual)) by the Gpt return rate “10(%)” for the player C. The benefit assigning unit 104 calculates the paid point “120 (Ppt)” obtained by multiplying the second value cash “3000 (yen)” to be paid as the second benefit (supplementary prize Ppt (individual)) by the Ppt return rate of “4(%)” for the player C. That is, the benefit assigning unit 104 calculates the benefit for the individual player according to the level of each team player and the reward to be paid.

Next, the benefit assigning unit 104 sums the first benefit and the second benefit for all the team players in the entire team. Specifically, the benefit assigning unit 104 sums the value of the free point (supplementary prize Gpt (individual)) which is the first benefit of the individual team players as the total of the first benefit and calculates “2150 (Gpt)” as the total free point of the entire team (supplementary prize Gpt (all)). The benefit assigning unit 104 sums the value of the paid point (secondary prize Ppt (individual)) which is the second benefit of the individual team players as the total of the second benefit and calculates “380 (Ppt)” as the total paid point of the entire team (supplementary prize Ppt (all)).

Finally, the benefit assigning unit 104 assigns the calculated total free point of the entire team to the team players who betted with free coins according to the free point. For the team player betting with the free coins according to the free point, the total free point for the entire team assigned as the benefit by the benefit assigning unit 104 and the refund free point (refund Gpt) paid as the reward by the payment process unit 105 become the total earned free point (total earned Gpt) of the team players. The benefit assigning unit 104 assigns the calculated total paid point for the entire team as total earned paid point (total earned point Ppt) to the team players who betted with the cash according to the paid point. That is, the benefit assigning unit 104 assigns the benefit of the entire time obtained by summing the benefits of the team player individuals and the benefit of another team player according to the type (first value/second value) of the predetermined value betted by each team player to each team player.

<5. Screen>

FIGS. 6A and 6B illustrate examples of the screen that displays the benefit assigned to the team players in the team T. The screen illustrated in FIGS. 6A and 6B may be displayed by performing the predetermined operation on the screen for receiving the designation of displaying the betting results by the team players. The visualization of the benefit as disclosed in the drawings and described herein provides a significant benefit, in that the user may receive the information to make the decisions that are required for the operation of the embodiments described herein.

As illustrated in FIG. 6A, the betting result screen A1 is a screen for displaying the race result of the tenth race for the player A. A list display area a10 for displaying the list of the race result of the tenth race and a result display area all for displaying the total earned money and total earned free point (total of the first benefits) from the race result of the tenth race for all the team players are included.

As illustrated in FIG. 6B, the betting result screen A2 is a screen for displaying the details of the race result of the tenth race for the player A. The betting result screen A2 includes a result detail display area a20 for displaying the details of the race result of the tenth race and a benefit display area a21 for displaying the benefit assigned to each team player in the team T of the tenth race, the level of each team player, and the degree of contribution to the team T according to the level of each team player. In the present example, the benefits displayed in the benefit display area a21 are the first benefit (free point) and the second benefit (paid point). In the present example, the degree of contribution based on the level of the team player is set to three stages of “high/medium/low”, and a trophy icon in the case of “high”, a medal icon in the case of “medium”, and a testimonial icon in the case of “low” are displayed immediately below the images representing the corresponding players. For example, the player A has a “low” degree of contribution based on the level 1 of the player own while the player C has a “medium” degree of contribution based on his level 15 of the player own. The team players can confirm how much the team players and other team players have contributed to the team T by referring to the screen in FIG. 6B.

<Process Procedure>

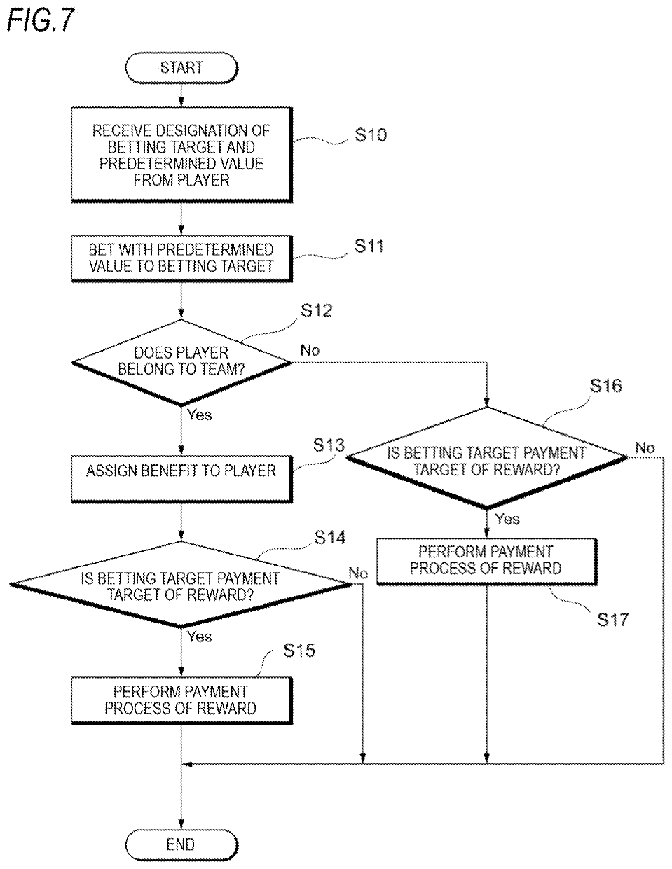

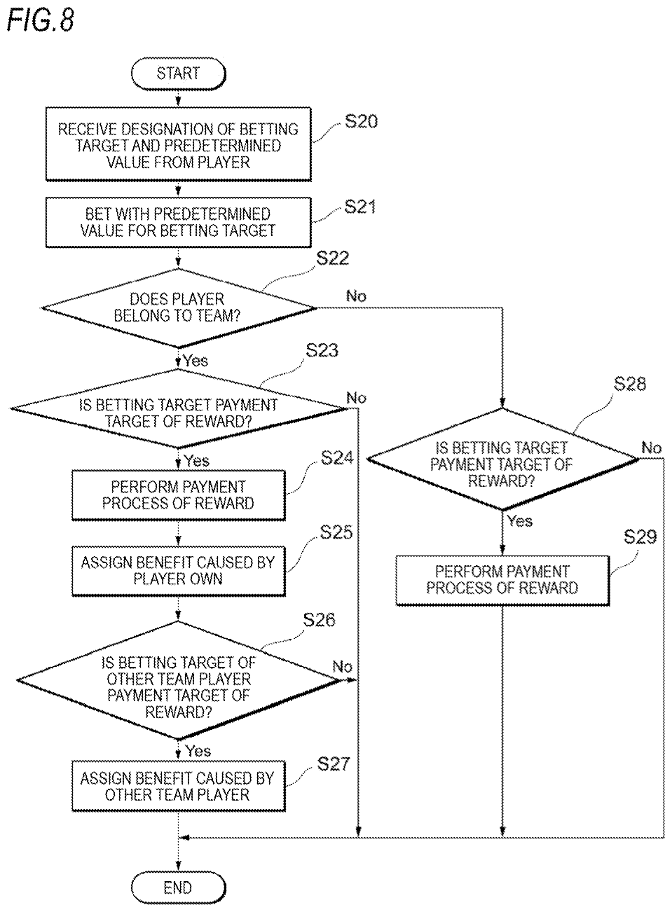

FIGS. 7 and 8 are flowcharts illustrating an example of the process procedure performed by the betting system 1. FIG. 7 illustrates an example in which the benefit is assigned when the player joins the team, and as another example, FIG. 8 illustrates an example in which the benefit is assigned when the player does not only join the team but also hit the bet. First, the process procedure performed by the server 10 and the terminal 20 in the example in which the benefit is assigned to the player on the condition that the player joins the team will be specifically described with reference to FIG. 7. Note that the process order of the process procedures in FIGS. 7 and 8 illustrated below is an exemplary one and may be changed as appropriate. Additionally, it should be noted that the process is performed on the hardware and storage structures disclosed above.

As illustrated in FIG. 7, the reception unit 102 of the server 10 receives the designation of the betting target and the predetermined value from the player via the screen of the terminal 20 (S10). The betting process unit 103 bets with the same received predetermined value for the betting target received by the reception unit 102 (for example, purchases the race-ticket when the game is a bicycle race) (S11).

When the server 10 determines that the player joins the team (Yes in S12), the benefit assigning unit 104 assigns the benefit to the player (S13). Note that “when the player joins the team” may be limited to when the player joins the team from the predetermined time while betting on the betting target is receivable until the game ends, and is determined by one or more signals received by the server 10. When the betting target betted with the predetermined value by the player is the payment target of the reward (Yes in S14), the payment process unit 105 performs the payment process of the reward to the player according to the predetermined value betted by the player (S15).

When the server 10 determines that the player is not joining the team (No in S12), the process proceeds to step S16. When the betting target betted with the predetermined value by the player is the payment target of the reward (Yes in S16), the payment process unit 105 performs the payment process of the reward to the player according to the predetermined value betted by the player (S17).

Next, in the example of assigning the benefit to the player on the condition that the player joined a team and that the bets of the player and other team players are hit, the process procedure performed by the server 10 and the terminal 20 will be specifically described with reference to FIG. 8.

As illustrated in FIG. 8, the reception unit 102 of the server 10 receives the designation of the betting target and the predetermined value from the player through the screen of the terminal 20 (S20). The betting process unit 103 bets with the same received predetermined value for the betting target received by the reception unit 102 (S21).

When the player joined the team (Yes in S22) and when the betting target betted with the predetermined value by the player is the payment target of the reward (Yes in S23), the payment process unit 105 of the server 10 performs the reward payment process according to the predetermined value betted by the player (S24). Here, the benefit assigning unit 104 of the server 10 assigns the benefit of the player individual player the player. That is, the benefit assigning unit 104 of the server 10 assigns the benefit resulting from the fact that the player own bet is hit to the player (S25).

When the betting target betted by another team player in the same team as the player is the payment target of the reward (Yes in S26), the benefit assigning unit 104 of the server 10 assigns the benefit to the player. That is, the benefit assigning unit 104 of the server 10 assigns the benefit resulting from the fact that the other team players of the same team as the player is hit to the player A (S27).

When the player is not joining the team (No in S22), the process proceeds to step S28. When the betting target betted with the predetermined value by the player is the payment target of the reward (Yes in S28), the payment process unit 105 performs the payment process of the reward to the player according to the predetermined value betted by the player (S29).

### Appendices According to First Embodiment

(Appendix 1)

An information processing apparatus receiving bets for each game in which betting is available for a betting target, the apparatus including:
a reception unit receiving designation of the betting target and a predetermined value from a player; and
a benefit assigning unit assigning a benefit to the player when a plurality of the players for a predetermined period or for the game can form a team and a predetermined condition including joining the team by the players and betting on the betting target is satisfied.

(Appendix 2)

The information processing apparatus according to appendix 1, in which the benefit assigning unit assigns the benefit to the player when the betting target betted by another player in the same team as the player is a payment target of a reward.

(Appendix 3)

The information processing apparatus according to appendix 1 or 2, in which the benefit assigning unit assigns the benefit to the player when the betting target received by the reception unit from the player is a payment target of a reward.

(Appendix 4)

The information processing apparatus according to any one of appendices 1 to 3, in which the benefit assigning unit assigns the benefit to the player according to a reward paid to the player in the same team as the player.

(Appendix 5)

The information processing apparatus according to any one of appendices 1 to 4, in which
the benefit assigning unit assigns the benefit to the player according to a level of one or a plurality of the players with betting target betted by the player being a payment target of the reward among the players in the same team as the player, and
the level is set according to at least one of the number of times betting by the player in the predetermined period, a predetermined value betted by the player, and an accumulated value of rewards paid to the player.

(Appendix 6)

The information processing apparatus according to appendix 5, in which the benefit assigning unit assigns the benefit to the player according to the highest level among the levels of the players in the same team as the player,

(Appendix 7)

The information processing apparatus according to any one of appendices 1 to 6, in which
the predetermined value includes a first value and a second value, and
when the player betted with the first value on the betting target, the benefit assigning unit assigns a first benefit according to the player betting with the first value among the players in the same team as the player, and when the player betted with the second value on the betting target, the benefit assigning unit assigns a second benefit according to the player betting with the second value among the players in the same team as the player.

(Appendix 8)

The information processing apparatus according to any one of appendices 1 to 7, in which the predetermined condition includes that the player joins the team from the predetermined time when the betting on the betting target is receivable until the game ends.

(Appendix 9)

A program for causing a computer receiving bets on a result of a game to function as, the program realizing:
a reception function of receiving designation of the betting target and a predetermined value from a player; and
a benefit assigning function of assigning a benefit to the player when a plurality of the players for a predetermined period or for the game can form a team and a predetermined condition including joining the team by the players and betting on the betting target is satisfied.

### Second Embodiment

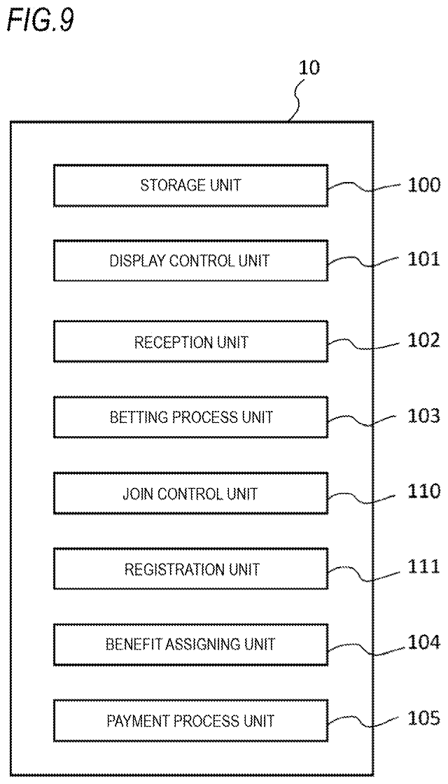

Next, a betting system 1 according to a second embodiment of the present disclosure will be described with reference to FIGS. 9 to 20. The betting system 1 according to the second embodiment is similar to the first embodiment in the system configuration illustrated in FIG. 1 and the hardware configuration illustrated in FIG. 2, and thus, the description thereof will be omitted. Note that, in the second embodiment, the first value is described as the paid point such as cash, and the second value is described as the free point.

FIG. 9 illustrates a functional block diagram of a server 10 according to the second embodiment. As illustrated in FIG. 9, the server 10 includes a storage unit 100, a display control unit 101, a reception unit 102, a betting process unit 103, a benefit assigning unit 104, a payment process unit 105, a join control unit 110, and a registration unit 111. The function of each component provided in the server 10 is realized by cooperation of the processor 11, the storage device 12, the communication IF 13, the input device 14, and the output device 15 of the server 10. Note that, in the following description, among the functions provided in the server 10 according to the second embodiment, differences from the functions provided in the server 10 according to the first embodiment will be mainly described, and the description with respect to the functions denoted by the same reference numerals as those of the server 10 and the functions common to the first embodiment will be omitted.

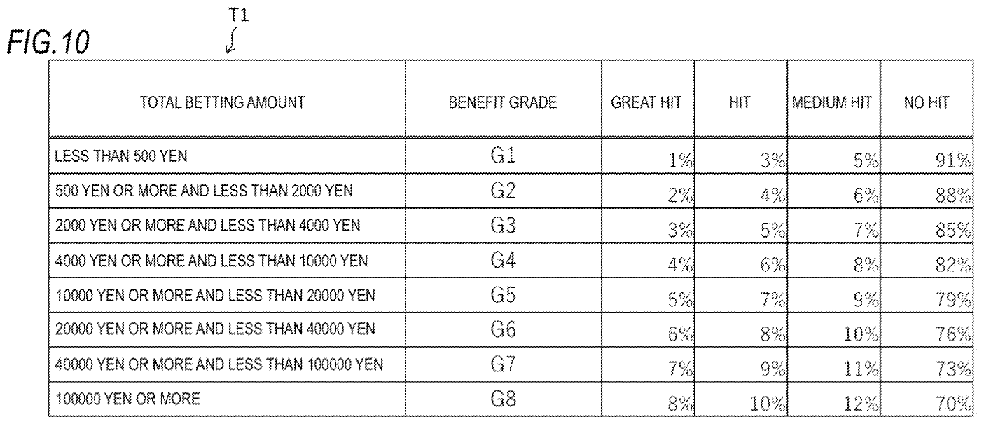

Various data are stored in the storage unit 100, and in the present embodiment, for example, a benefit grade information table T1 illustrated in FIG. 10 is stored.

As illustrated in FIG. 10, the information for determining the grade of the benefit assigned to the group according to the total betting amounts betted by the players in the same group (team) is stored in the benefit grade information table T1.

In the present embodiment, in the benefit grade information table T1, the benefit grade is set for each range of the total betting amount of betting tickets designated with the first value among the betting tickets betted for the same race by the players in the same group.

The benefit grade refers to the classification of the benefit that can be obtained by in the group and betting, and when the total betting amount is large, the benefit is set to be more advantageous/lucrative than when the total betting amount is small. Specifically, in the present embodiment, eight levels from G1 to G8 are set for the benefit grades, and for each benefit grade from G1 to G8, the probabilities/hitting percentages of drawing “great hit”, “hit”, “medium hit”, and “no hit” are determined. For example, it is configured that, as the benefit grade increases from G1 to G8, the probabilities/hitting percentages of drawing “great hit”, “hit”, and “medium hit” increase and the probability of “no hit” decreases, but FIG. 10 is an exemplary one, and the settings of the benefit grade is not limited thereto. As illustrated in FIG. 10, for each benefit grade, the sum of hitting percentages associated with “great hit, “hit”, “medium hit”, and “no hit” comes to 100%. As benefit grade moves up, hitting percentage associated with each of “great hit”, “hit”, and “medium” is increased by 1% from preceding benefit grade. On the other hand, hitting percentage associated with “no hit” is reduced by 3%. Using benefit grades G1 and G2 as example, hitting percentage associated with each of “great hit”, “hit”, and “medium” is increased from 1%, 3%, and 5% to 2%, 4%, and 6% respectively, while chance of hitting “no hit” is reduced from 91% to 88%. The drawing/lottery process is described in more details below.

Join Control Unit 110

The join control unit 110 of the server 10 allows other players to join the group when one of the plurality of players has betted for the game. In the present embodiment, the join control unit 110 sets the player who has betted for the game and who has made the request to recruit joining the group as the host player, and the join control unit 110 of the server 10 recruits the guest players to join the group that bets for the game together with the host player. In some example implementations, the guest players are selected by the player who initiated game betting through social network information, where the initiating player and the guest players are friends in a social network. Social network information of the players is communicated to the join control unit 110 of the server 10 to facilitate guest player recruitment.

When the host player has performed the betting for the predetermined race, the join control unit 110 of the server 10 may provide authorization the terminal 20 of the host player, such as by access control group or the like, to display the screen for recruiting joining the group and receive the above-described request. Note that, the join control unit 110 of the server 10 may set the period during which joining the group is available to, for example, a period from when the host player starts recruiting until the deadline of the betting for the predetermined race.

When recruiting guest players, if the host player sets a password, the join control unit 110 may control to allow the guest player who has entered the password set by the host player to join the group of the host players.

The join control unit 110 of the server 10 may provide a signal to display information on a display device at one or more terminals 20 about betting information indicating that the players joining the group bets on the predetermined screen where other players perform operations for joining the group. That is, as the host player recruits joining the group, the terminals 20 of the other players display the predetermined screens for displaying the information about the group for which the joining recruitment is performed and performing the operation to join the desired group, based on the signal from the server 10.

The information about the betting tickets of the players who have already joined the group and information about the betting amounts designated in the betting tickets may be displayed on the predetermined screen of the one or more terminals 20, based on the signal received from the server 10.

Note that, the information about the betting amount designated with the betting ticket may include at least one of the total betting amounts of the first value and the total betting amounts of the second value designated with the betting ticket of each player in the group.

The join control unit 110 of the server 10 may display rank information (for example, level) of each player in the group on the predetermined screen. The rank information is player attribute information that is updated based on the betting history of the player, and players with higher rank information is more likely to be assigned advantageous benefit than players with lower rank information. Herein, the advantageous benefit denotes, for example, that the benefit is large in amount, that the benefit is rare, or the like.

The join control unit 110 of the server 10 may provide a signal for the predetermined screen of the one or more terminals 20 to display the benefit grade information according to the total betting amounts of the first value betted by the players in the group when the predetermined screen is displayed. Note that the benefit grade information is designated based on the benefit grade information table T1 illustrated in FIG. 10, which may be stored in a storage associated with a server 10.

The join control unit 110 allows the benefit grade information at the timing (the first timing) when the predetermined screen at the one or more terminals 20 is displayed as well as the information of the betting amount of the first value required to upgrade the benefit grade information on the predetermined screen. That is, when the benefit grade information satisfied by the group at the first timing is G2, the join control unit 110 of the server 10 may generate and provide a signal to the one or more terminals 20 to display the information about the difference in the betting amount required, to raise the benefit grade information to G3 on the predetermined screen of the one or more terminals 20. Note that the betting amount required to raise the benefit grade information to the next grade can be determined by referring to the benefit grade information table T1, which may be stored in a storage associated with a server 10.

Registration Unit 111

The registration unit 111 of the server 10 registers the plurality of players including the first player and the second player as the group. For example, when the first player is a host player, the registration unit 111 registers the second player as a guest player in association with each other. Here, after the first player recruits for joining the group and the second player requests for joining the group, and when the members of the group are confirmed, the first player and the second player are registered in the same group. An upper limit value may be set for the number of participants in the group, and stored in memory. Here, the upper limit value may be set according to the attributes of the host player. In the above-described example, the first player is the host player, but the second player may be the host player.

The registration unit 111 of the server 10 registers the player who receives joining during the period in which joining the group is available as the participant of the group. Herein, the period during which joining the group is available may be the period during which the betting is available for the game in which the first player is betting. The period during which the betting for the game is available may be a period until the betting deadline before the game starts or until the game starts.

Reception Unit 102

The reception unit 102 of the server 10 receives first betting information from the one or more terminals 20 about which the first player bets and the second betting information about which the second player bets for the game.

Herein, the reception unit 102 of the server 10 can receive the betting information/bet placement designating at least one of the first value and the second value from each of the plurality of players for the game, from the one or more terminals 20. That is, the first betting information includes information about the betting target and the betting value designated by the first player, and at least one of the first value and the second value is designated as the betting value. The second betting information includes information about the betting target and the betting value designated by the second player, and at least one of the first value and the second value is designated as the betting value.

Benefit Assigning Unit 104

The benefit assigning unit 104 of the server 10 assigns the first benefit determined based on the first betting information to the first player. Herein, the first benefit is a benefit different from the hitting money/reward that is refunded when the betting target designated in the first betting information is hit, and the first benefit is a benefit assigned to the first player even when the betting target is hit or not hit.

The benefit assigning unit 104 of the server 10 may determine the first benefit according to the first value based on the betting information designating the first value among the first betting information and may determine the first benefit according to the second value based on the betting information designating the second value among the first betting information, respectively.

For example, the benefit assigning unit 104 of the server 10 determines the first benefit based on the benefit grade information according to the total betting amounts of the first value betted by the players in the group and the first betting information. Specifically, the benefit assigning unit 104 of the server 10 determines the first benefit according to the first value based on the benefit grade information determined for the group and whether the betting ticket designated with the first value for the first betting information is hit.

More specifically, when the benefit grade of the group is G2 and the betting ticket with the first value hits from the first betting information, a “hit box” is used in determining the first benefit according to the first value (e.g., a benefit given when the betting based on the first value (paid value) is won). When the betting ticket with the first value misses based the first betting information, then a “no hit box” is used in determining the first benefit according to the first value.

For example, in the “hit box”, a return according to the total betting amounts (first target amount) betted by the participants of the group using the first value is set according to a lottery/drawing. For example, when four lottery results for the “hit box” are “great hit”, “hit”, “medium hit”, and “no hit”, benefits of “great hit”, the “hit”, the “medium hit”, and the “no hit” may be set to five times (500%) the first target amount, 100% of the first target amount, 20% of the first target amount, and 0.1% of the first target amount, respectively. In some example implementations, benefit levels may vary across different benefit grades. For example, while “great hit” associated with the benefit grade of G4 may have a benefit multiplier of 5 (500% of the first target amount), “great hit” associated with the benefit grade of G6 may have a benefit multiplier of 5.5 (550% of the first target amount).

Then, under the “no hit box”, the second value or the point obtained by betting designating the second value may be obtained as the benefit through random selection/drawing.

The benefit assigning unit 104 of the server 10 determines the first benefit according to the second value based on the benefit grade information determined for the group and whether the betting ticket designated with the second value for the first betting information is hit.

For example, when the benefit grade of the group is G2 and the betting ticket with the second value hits from the first betting information, a “hitting bag” (drawing or random selection) is used to determine the amount of the first benefit based on the second value (e.g., a benefit given when the betting based on the second value (non-paid value) is won). When the betting ticket with the second value misses based on the first betting information, then drawing from a “no hit bag (same as the no hit box)” is used in determining the first benefit according to the second value. The benefit assigning unit 104 of the server 10 performs the drawing function through a random generator, which may be incorporated as part of the benefit assigning unit 104 of the server 10 for benefit selection. In some example implementations, the random generator function is performed by a random generator unit that is separate from the benefit assigning unit 104 and exists on the server 10, which receives a request from the benefit assigning unit 104 for performance of random benefit selection.

For example, in the “hitting bag”, a return is set according to the total betting amounts (second target amount) betted by the participants in the group by using the second value according to the lottery. For example, when the lottery results in the “hitting bag” include “great hit”, “hit”, “medium hit”, and “no hit”, the benefits may be set to 500% of the second target amount, 100% of the second target amount, 20% of the second target amount, and of the second target amount, respectively.

The benefit assigning unit 104 of the server 10 assigns the first benefit to the second player when the second betting information satisfies the predetermined condition. Herein, the benefit assigning unit 104 may determine whether to assign the first benefit to the second player based on the betting value in the second betting information. This may be accomplished by the storage of the information in the storage unit 100, for example.

For example, when the first value is designated to the second betting information, the benefit assigning unit 104 may assign the first benefit to the second player regardless of whether the first betting information designates the first value or the second value. That is, when the first value is designated in the second betting information, both the first benefit according to the first value and the first benefit according to the second value are assigned to the second player.

For example, when only the second value is designated in the second betting information, the benefit assigning unit 104 of the server 10 may assign the first benefit to the second player when the first betting information designates the second value. That is, when only the second value is designated in the second betting information and the first value is not designated, only the first benefit according to the second value is assigned to the second player.

The benefit assigning unit 104 may assign the second benefit determined based on the second betting information to the second player and may assign the second benefit to the first player when the first betting information satisfies the predetermined condition. That is, the same process as described above may be performed for each player in the group.

The benefit assigning unit 104 of the server 10 may determine the amount of the first benefit to be assigned to the first player with the probability according to the rank information set based on the betting history for the first player and may assign the determined amount of the first benefit to the second player when the second betting information satisfies the predetermined condition.

For example, the benefit assigning unit 104 of the server 10 may determine the amount based on the rank information (for example, level) of the first player for each of the first benefit according to the first value and the first benefit according to the second value. The benefit assigning unit 104 of the server 10 increases the possibility that the amount will increase when the rank information of the first player is high compared to when the rank information of the first player is low. Specifically, the benefit assigning unit 104 of the server 10 draws lottery so that the number of first benefits according to the first value is one or two with the probability according to the rank information of the first player. Similarly, the benefit assigning unit 104 of the server 10 draws lottery so that the number of first benefits according to the second value is one or two with the probability according to the rank information of the first player.

The benefit assigning unit 104 of the server 10 may execute the same process as the above-described for each player included in the group.

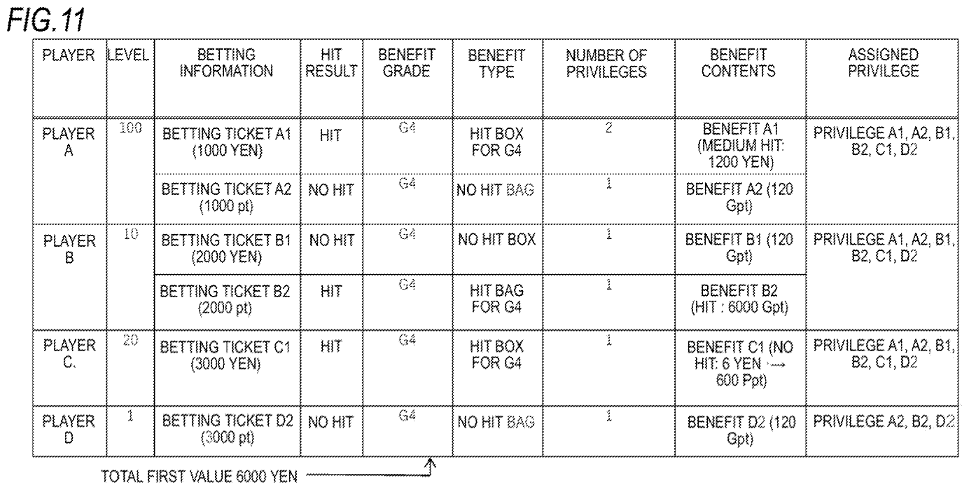

Herein, referring to the specific example illustrated in FIG. 11, the determining process of the benefit to be assigned to the players A to D in the group by the benefit assigning unit 104 will be described.

As illustrated in FIG. 11, a player A bets with the betting ticket A1 designating the first value and the betting ticket A2 designating the second value, by providing the input to the one or more terminals 20. A player B bets with a betting ticket B1 designating the first value and a betting ticket B2 designating the second value, by providing the input to the another of the one or more terminals 20. A player C bets with a betting ticket C1 designating the first value, by providing the input to another of the one or more terminals 20, and a player D bets with a betting ticket D1 designating the second value, by providing the input to the still another of the one or more terminals 20.

Herein, the benefit grade of the group is determined at the server 10 from the benefit grade information table T1 based on the total betting amounts of the betting tickets designating the first value of the players A to D. In the present example, since the sum of the amounts of the first value is 6000 yen, the benefit grade is G4 from the benefit grade information table T1.

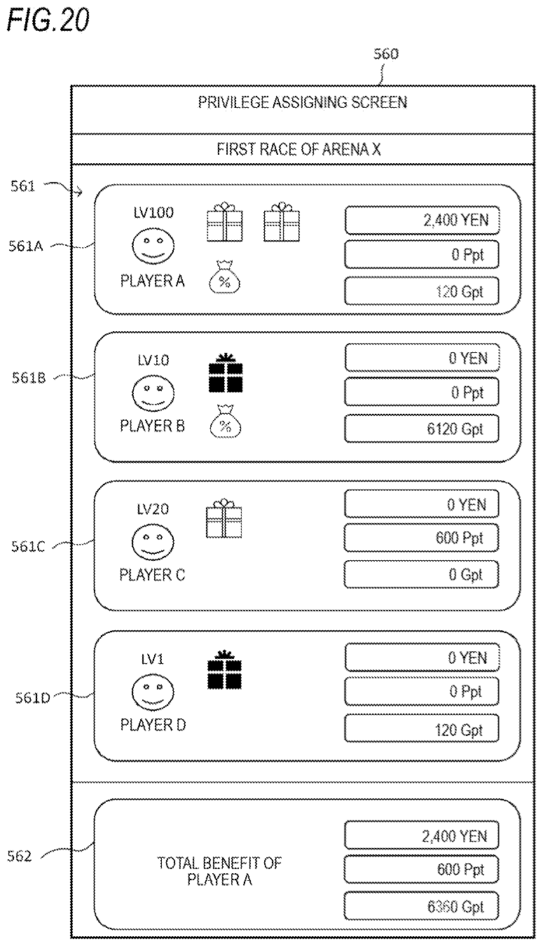

Next, assuming that the hitting result of the respective betting tickets are as illustrated in FIG. 11 from the result of the game, the first benefit (benefit A1) according to the first value of the player A becomes “hit box of G4”, and the first benefit (benefit A2) according to the second value becomes the “no hit bag”. As the result of lottery for the number of benefits/privileges for the player A, it is assumed that the number of benefits for the benefit A1 is two and the number of benefits for the benefit A2 is one. With respect to betting ticket A1, as shown in FIG. 11, 1200 yen corresponds to a single value of the benefit. Because the value of the of the privilege is “2”, the benefit is multiplied by the privilege, for a total of 2400 yen, as shown in FIG. 20. With respect to betting ticket A2, the value of 120 Gpt is obtained by multiplying 6000 points (total second value) by 2% (predetermined value).

For the players B to D, the types of benefit and the number of benefits are determined according to the first value and the second value, respectively. For example, with respect to C, 6 yen is calculated based on 0.1% (predetermined value) of 6000 yen, and 6000 yen is exchanged to 600 Ppt by a predetermined rate. Thus, 600 PPt is given to player C, as the value of 6 yen is applied for the purpose of calculating the Ppt value.

Next, the benefit assigning unit 104 of the server 10 determines the content of the benefit determined for each of the players A to D. Specifically, for each benefit, the lottery is executed with the probability according to the benefit grade as illustrated in FIG. 10, and the contents thereof are determined. In the present example, the result of the lottery for each benefit are as illustrated in FIG. 11.

Next, the benefit assigning unit 104 of the server 10 determines the benefit to be assigned to each player in the group. Specifically, in the example illustrated in FIG. 11, since the players A to C have performed the betting designated with the first value, the benefit assigning unit 104 of the server 10 assigns all the benefits including the benefit assigned to the other players in the group. On the other hand, since the player D has performed only the betting designated with the second value, among the benefits assigned to other players in the group, only the benefits (in this example, the benefits A2, B2, and D2) assigned by the betting designated with the second value are assigned.

When the total betting amounts of the first value of the players in the group satisfy the first condition, the benefit assigning unit 104 of the server 10 draws a lottery to determine whether to assign the third benefit to the group, and when the third benefit is assigned to the group, the third benefit may be assigned to the player who bets by designating the first value among the players in the group.

The above-described first condition may be the condition that the total betting amounts of the first value in the target race is the predetermined threshold or more, the first condition may be the condition that the total betting amounts of the first value in the target race bets for the race is the predetermined rank or more among the groups that are betting for the race.

For example, the benefit assigning unit 104 of the server 10 may extract the predetermined number of groups with the highest total betting amounts of the first value among the plurality of groups that betted for the game of the target and may assign the third benefit with respect to at least one group on which the lottery is drawn among the extracted groups. For example, the third benefit may be paid value, such as the first value. Each group may be notified in advance whether the group is the assignment target of the third benefit before the betting deadline.

Description of Sequence

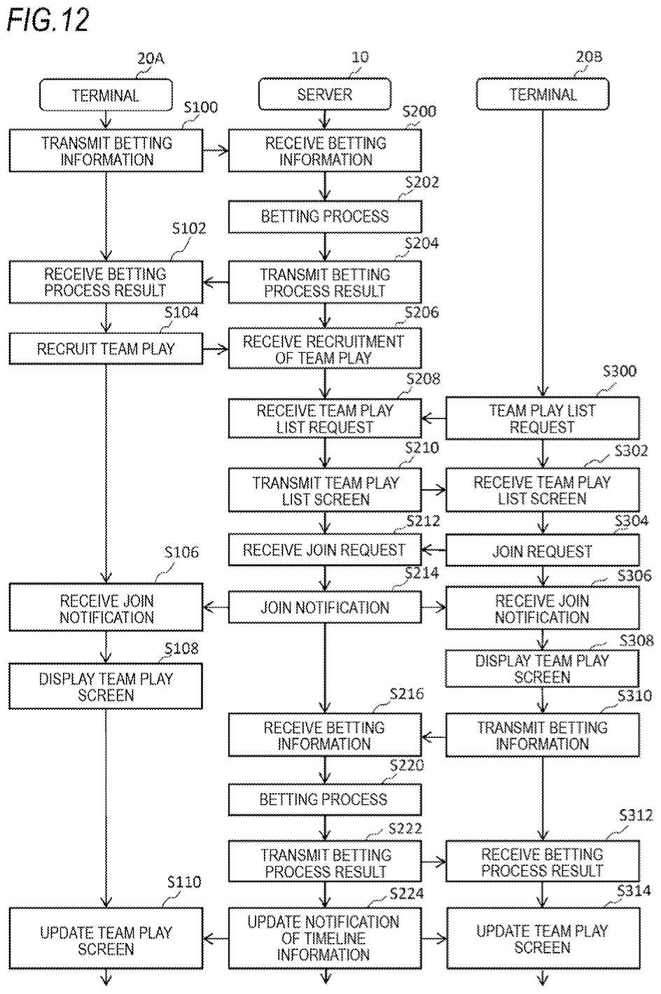

Next, details of the processes executed in the betting system 1 according to the second embodiment will be described with reference to FIGS. 12 to 20.

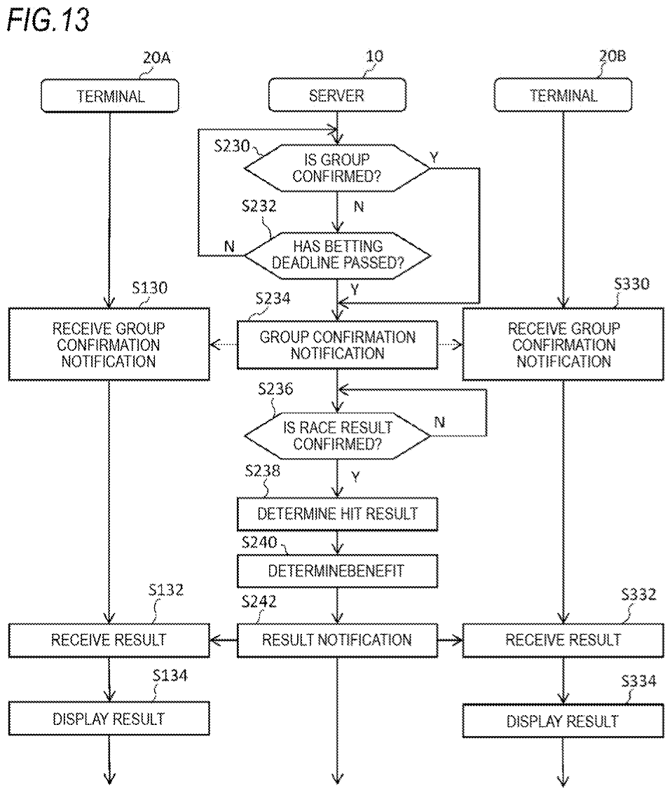

FIGS. 12 and 13 are sequence diagrams of processes executed in the betting system 1. Note that, in the following description, the terminal 20 operated by the host player A is referred to as a terminal 20A, and the terminal 20 operated by the guest player B is referred to as a terminal 20B.

As illustrated in FIG. 12, the terminal 20A transmits the betting information received from the player A to the server 10 (S100).

The server 10 receives the betting information from the terminal 20A (S200), executes a betting process based on the received betting information (S202), and transmits the result of the betting process to the terminal 20A (S204).

The terminal 20A receives the result of the betting process from the server 10 (S102), and displays the screen displaying the received result of the betting process on the display of the terminal 20A.

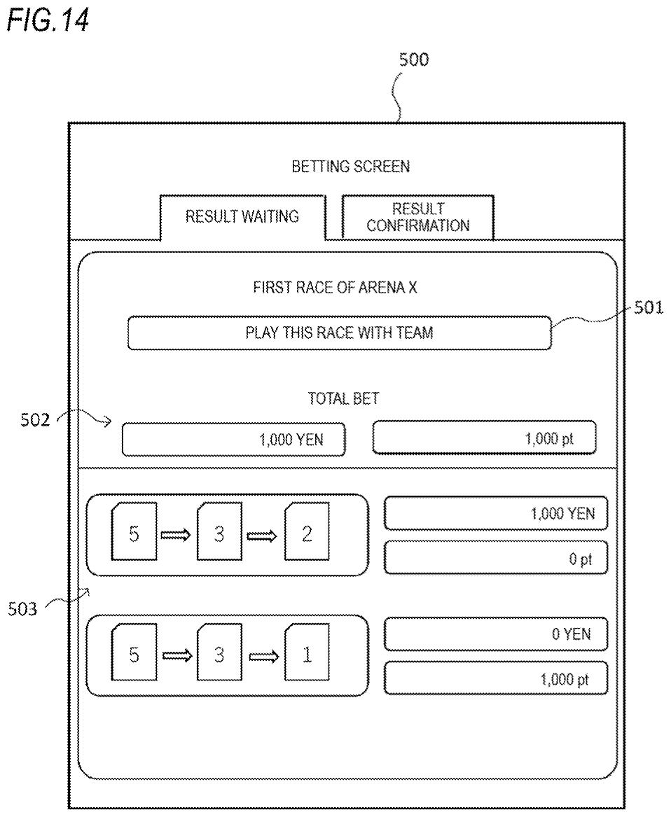

FIG. 14 illustrates an example of the betting screen 500 displaying the result of betting process. Betting screen 500 corresponds to betting information generated and displayed on terminal 20A at step S102 of FIG. 12. As illustrated in FIG. 14, the betting screen 500 of the terminal 20A includes a user input section such as button 501 according to the operation for recruiting joining the group, a betting amount information display area 502, and a betting ticket information display area 503.

In the betting amount information display area 502 of the terminal 20A, the information about the betting amount betted for the target race by the player A is displayed, and in the present example, the total of the amounts of the first value and the second value is aggregated and displayed.

In the betting ticket information display area 503 of the terminal 20A, the information of the betting ticket that the player A betted for the target race is displayed.

When the terminal 20A receives a user input and senses or detects that the button 501 is activated or pressed, the terminal 20A transmits a signal to notify the server 10 of recruiting the members for team play (S104).

When the server 10 receives a signal associated with a team play recruitment request from the terminal 20A (S206), the server 10 registers the team play information including information about the host player and the target race based on the received information, such as by storing in the storage unit 100. Note that the team play information may include settings of a password or other authentication approaches as would be known by those skilled in the art.

When the terminal 20A receives the team play recruitment request based on the user input, the server 10 generates a signal for the terminal 20A to display a recruitment screen 510 on its display.

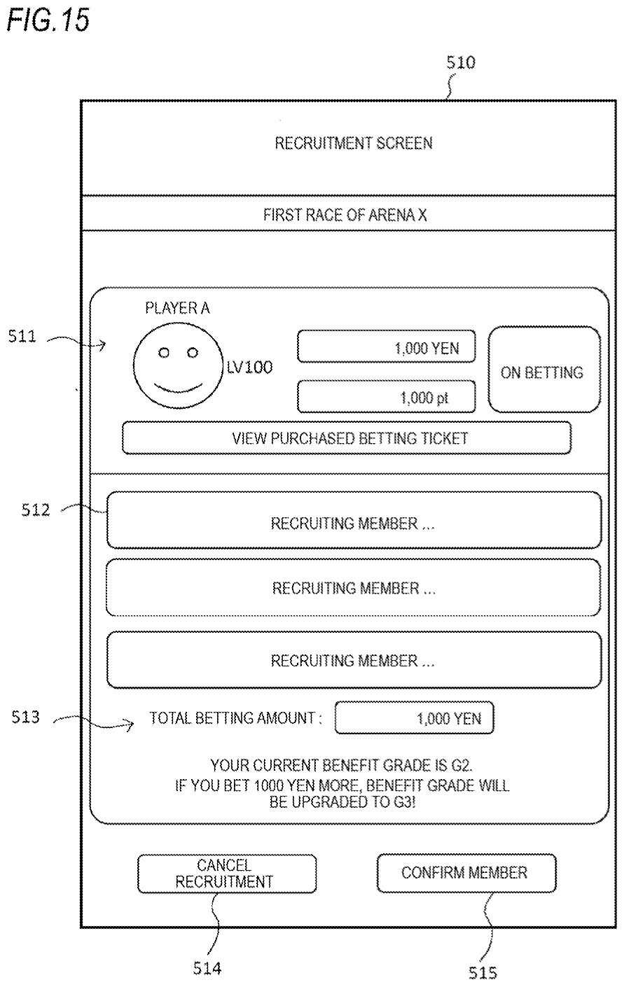

As illustrated in FIG. 15, the recruitment screen 510 includes a host player information display area 511, a number-of-joinable-player display area 512, a betting information display area 513, a cancel button 514, and a confirmation button 515. Recruitment screen 510 corresponds to recruitment request information generated and displayed on terminal 20A at step S104 of FIG. 12.

The host player information display area 511 of terminal 20A displays the information of the players who are recruiting for the group is displayed, and in the present example, displays a total of each of the first value and the second value designated with the betting ticket with which the player bets.

The number-of-joinable-player display area 512 of the terminal 20A displays information about players in the group as the guest players. For example, when the number of players who can join the group is four, three of the players become a frame of guest players, and the empty frame is displayed to the message indicating that the three of the players are guest players.

In the betting information display area 513 of the terminal 20A, displayed are the total first value betted for the target race by all players currently in the group, the information about the benefit grade achieved by the total first value, and the information about the betting amount required to upgrade to the next benefit grade.

The cancel button 514 of the display on the terminal 20A is an operation button for canceling the recruitment of the groups, and the confirmation button 515 of the display on the terminal 20A is an operation button for confirming the members of the group.

Next, the process for allowing another player (assumed to be the player B) to join the group recruited by player A will be described.

As illustrated in FIG. 12, the terminal 20B generates and transmits a signal that includes a request to the server 10 for the list information of the groups recruiting the members for the team play (S300). When generating the signal requesting the list information, the terminal 20B may including one or more commands to perform the condition designation such a target race and designation of password and request the server 10 to extract the group satisfying the condition.

The server 10 receives the request from the terminal 20B (S208), extracts the group matching the received request, generates the screen data for displaying the list of groups, and transmits the a signal that includes the screen data to the terminal 20B (S212).

The terminal 20B receives the screen data from the server 10 (S302) and displays the screen on the display of the terminal 20B based on the screen data.

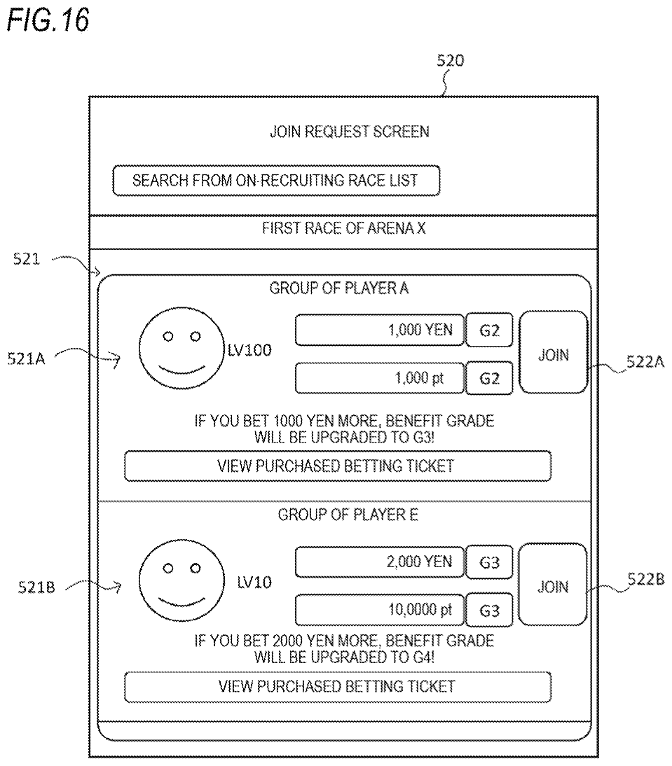

FIG. 16 illustrates an example of a join request screen 520 displayed on the display of terminal 20B in the above-described process.

As illustrated in FIG. 16, the join request screen 520 of terminal 20B includes a group list display area 521. The group list display area 521 of terminal 20B is an area for displaying the list of groups matching the condition requested by the player B, and in the present example, two groups are extracted, but the present disclosure is not limited thereto.

The group list display area 521 of terminal 20B includes a first group display area 521A and a second group display area 521B.

In the first group display area 521A of terminal 20B, displayed is the information about the group of the player A as the first group, and displayed are the total betting amounts of the first value and the second value of the players in the first group, the information about the benefit grade, and information required to upgrade the benefit grade to be referenced.

The player B can join the first group by pressing a join button 522A of terminal 20B.

Similarly, in the second group display area 521B of terminal 20B, displayed is the information about the group of the player E as the second group, and displayed are the total betting amounts of the first value and the second value of the players in the second group, the information about the benefit grade, and information required to upgrade the benefit grade.

The player B can join the second group by pressing a join button 522B of terminal 20B.

The terminal 20B generates and transmits a signal to request the server 10 to join the selected group, for example, when receiving the operation of the join button 522A of terminal 20B from the player B (S304).

The server 10 receives a join request from the terminal 20B (S212), and when the target group is enabled to join, the server 10 allows the player B to join the group and notifies the terminal 20A and the terminal 20B that the player B joins the group (S214).

The terminal 20A receives the notification from the server 10 (S106), and displays information about the group on the team play screen displayed on the terminal 20A (S108).

Similarly, the terminal 20B receives the notification from the server 10 (S306), and displays the information about the group on the team play screen displayed on the terminal 20B (S308).

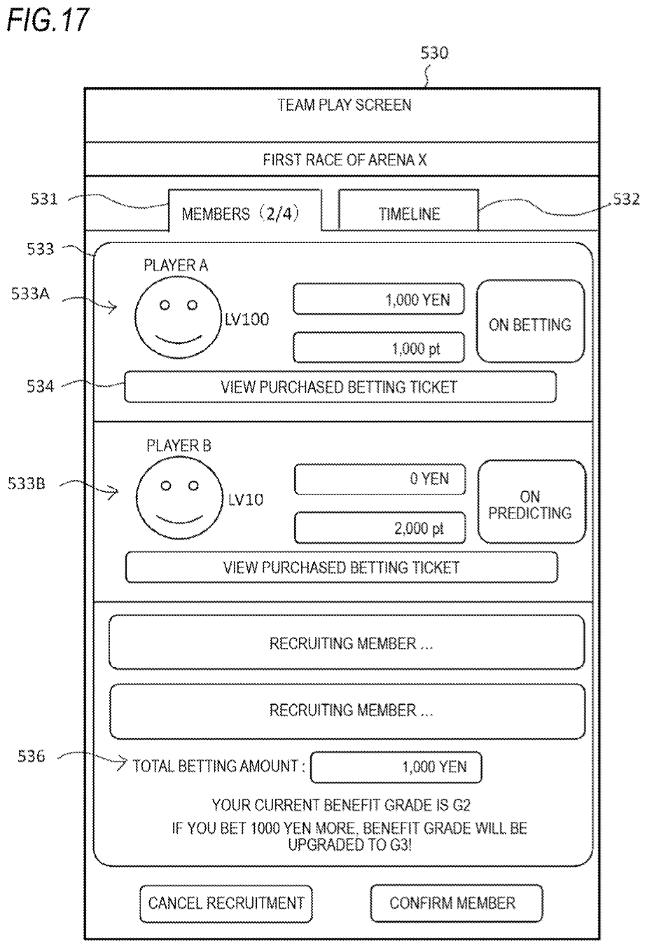

FIG. 17 illustrates an example of a team play screen 530 displayed on the terminal 20B in S308.

As illustrated in FIG. 17, the team play screen 530 of terminal 20B includes a member screen tab 531 and a timeline screen tab 532.

The member screen tab 531 is an area for displaying information about the players in the group.

Specifically, the member screen tab 531 of terminal 20B includes a member information display area 533, and the member information display area 533 of terminal 20B includes a first member display area 533A, a second member display area 533B, and a betting information display area 536.

The first member display area 533A of terminal 20B can confirm the information of the betting ticket purchased by the player displayed in the member display area 533A by including the information about the host player and the information about the total betting amounts of the first value and the second value betted by the host player and by selecting a purchased race-ticket display button 534.

The second member display area 533B of terminal 20B is information about the first guest player, and the displayed data may be the same as the first member display area 533A of terminal 20B.

In the betting information display area 536 of terminal 20B, displayed are the total first value betted for the target race by all the players currently in the group, the information about the benefit grade achieved by the total first value, and the information about the betting amount required to upgrade to the next benefit grade.

The timeline screen tab 532 of terminal 20B is a screen that displays the history of operations of the players in the group, and the details will be described later. Note that the operations of the player include player join, betting, message transmission, and the like.

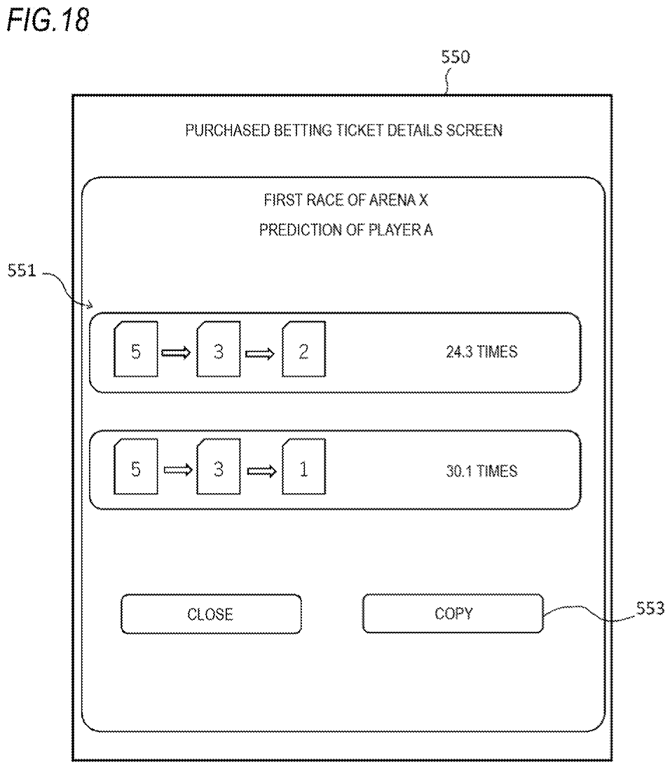

Herein, FIG. 18 illustrates an example of a purchased betting ticket details screen 550 displayed when the betting information display area 536 is selected on the team play screen 530 of FIG. 17, associated with the display of terminal 20B.

As illustrated in FIG. 18, the betting ticket information display area 551 and an impulsive bet button 553 are included in the purchased betting ticket details screen 550.

The betting ticket information display area 551 of terminal 20B is an area for displaying information about the betting ticket which the player A is betting with, and for example, the player B can bet based on the betting ticket which the player A is betting with by selecting the copy bet button 553. Herein, the “copy bet” denotes purchasing the betting ticket based on the betting ticket betted by another player.

When the terminal 20B receives, for example, the designation of the betting amount after receiving the selection of the copy bet button 553 from the player B, the terminal 20B transmits the betting information of the player B to the server 10 (S310).

When the server 10 receives the betting information from the terminal 20B (S216), the server 10 executes the betting process based on the betting information (S220), and transmits the result of the betting process to the terminal 20B (S222). Then, the terminal 20B receives the result of the betting process from the server 10 (S312).

The server 10 updates the timeline information of the group in response to the betting process being performed and notifies the terminal 20 of each player in the group of the updated timeline information (S224).

When receiving the update notification of the timeline information from the server 10, the terminals 20A and 20B update the team play screen based on the received information (S110 and S314).

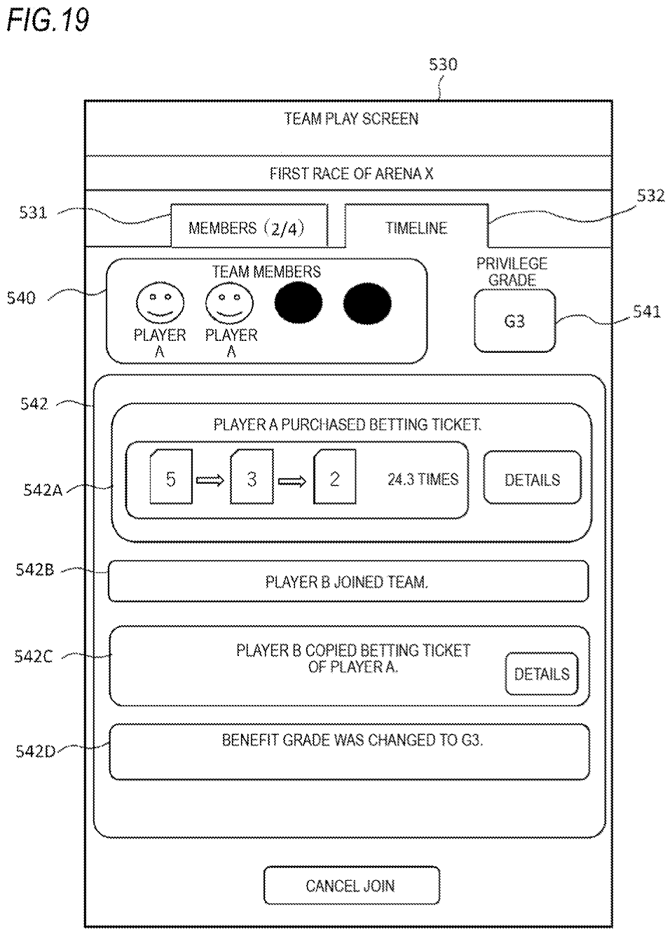

FIG. 19 illustrates an example of the team play screen 530 displayed on the terminal at step S308 of FIG. 12.

As illustrated in FIG. 19, the timeline screen tab 532 of the team play screen 530 of terminal 20B includes a member display area 540, a benefit grade display area 541, and a timeline display area 542.

The member display area 540 displays information about the players in the group.

The benefit grade display area 541 displays information about the benefit grade currently set for the group according to the betting amount of the players in the group.

The operation history of the players in the group is displayed on the timeline display area 542 of terminal 20B. In the present example, a first message 542A, a second message 542B, a third message 542C, and a fourth message 542D are displayed on the timeline display area 542.

The first message 542A is a message according to the betting history of the player A, the second message 542B is a message indicating that the player B has joined, the third message 542C is a message indicating that player B has copied betting of the betting ticket of the player A, and a fourth message 542D is a message indicating that the benefit grade of the group has been raised from G2 to G3 by the betting of the player B.

As such, to display the operations of the players in the group and messages such as chats, the timeline display area 542 can activate communication within the group.

Next, the process of confirming the group and assigning the benefit to the player in the group performed in the betting system 1 will be described with reference to FIG. 13.

As illustrated in FIG. 13, the server 10 receives the group confirmation request from the terminal 20A (S230: Y), or when the betting deadline for the target race has passed (S232: Y), the server 10 transmits the group confirmation notification to the terminal 20 of each player in the group (S234). The terminal 20 of each player in the group receives the group confirmation notification from the server 10 (S130 and S330).

On the other hand, when the group confirmation request has not been received (S230: N) and the betting deadline has not yet passed (S232: N), the process returns to S230.

Next, the server 10 waits until the result of the target race is confirmed (S236: N), and when the result of the target race is confirmed (S236: Y), the server 10 determines the hitting result based on the betting ticket information of each player (S238). The hit result is determined by determining the hit amount for each betting ticket according to the betting ticket, the odds, and the betting amount.

The server 10 determines the benefit for each player based on the betting ticket information for each player (S240). This benefit determination process is executed by the benefit assigning unit 104.

Next, the server 10 notifies the terminal 20 of each player in the group of the process results of S238 and S240 (S242).

The terminal 20 of each player receives the result of the target race from the server 10 (S132 and S332) and displays the result on the display (S134 and S334).

Herein, FIG. 20 illustrates an example of a benefit assignment screen 560 displayed on the display of the terminal 20A at step S134 of FIG. 13.

As illustrated in FIG. 20, the benefit assignment screen 560 includes a benefit information display area 561 and an assigned benefit display area 562.

The benefit information display area 561 of terminal 20B includes a first player benefit display area 561A for displaying the benefit determined based on the betting information of the first player, a second player benefit display area 561B for displaying the benefit determined based on the betting information of the second player, a third player benefit display area 561C for displaying the benefit determined based on the betting information of the third player, and a fourth player benefit display area 561D for displaying the benefit determined based on the betting information of the fourth player. For example, the benefit of player A is 2400 yen, which is the benefit value of 1200 yen multiplied by the privilege multiplier of “2” as explained above with respect to FIG. 11.

The assigned benefit display area 562 of terminal 20B displays a total of the benefits assigned to the player including the benefit information of the other players in the group for the player A who is the first player.

Note that, when the third benefit is assigned to the group, information about the third benefit may be added. Whether the third benefit is assigned may be displayed together with a performance image, for example, after the benefit assignment screen 560 of terminal 20B is displayed.

According to the betting system 1 according to the second embodiment described above, the plurality of players form the group and bet for the race, and by obtaining the benefit based on the betting information of other players in the group, more advantageous benefit than the of not forming the group is easily obtained. This is possible due to the interaction of the server 10 and terminals 20A, 20B in the manner explained above, so as to provide a sequence of operations and displays that permits players to be able to form a group, and to be able to bet on the race, based on the betting information of other players in the group, and to do so in a manner that provides an incentive to forming the group, as opposed to not forming the group or playing individually. By providing the arrangement of the server and terminals, and the associated signals, operations and displays in the specialized structures and processes set forth above, it is possible to improve the motivation of the plurality of players to form the group and bet.

### Appendix According to Second Embodiment

(Appendix 1)

An information processing apparatus receiving bets for a result of a game, the apparatus including:
a registration unit that registers a plurality of players including a first player and a second player as a group;
a reception unit receiving first betting information indicating the betting of the first player for the game and second betting information indicating the betting of the second player for the game; and
a benefit assigning unit that assigns a first benefit determined based on the first betting information to the first player, wherein
the benefit assigning unit assigns the first benefit to the second player when the second betting information satisfies a predetermined condition.

According to (Appendix 1), when the first player and the second player are registered as the group, the benefit assigned to the first player by the betting of the first player can also be assigned to the second player when the betting of the second player satisfies the predetermined condition. Accordingly, it is possible to improve the motivation of the plurality of players to form the group and bet.

(Appendix 2)

The information processing apparatus according to appendix 1, in which the benefit assigning unit assigns the second benefit determined based on the second betting information to the second player, and assigns the second benefit to the first player when the first betting information satisfies the predetermined condition.

According to (Appendix 2), when the first player and the second player are registered as the group, the benefit assigned to the second player by the betting of the second player can also be assigned to the first player when the betting of the first player satisfies the predetermined condition. Accordingly, it is possible to further improve the motivation of the plurality of players to form the group and bet.

(Appendix 3)

The information processing apparatus according to appendix 1 or 2, further including a join control unit enabling other player to join the group when some players of the plurality of players perform betting for the game, in which
the registration unit registers the player receiving joining during the period in which joining the group is available as a participant of the group.

According to (Appendix 3), since there is at least one player who is betting in the group, the player newly joining the group is more likely to obtain the benefit by the betting. Accordingly, a psychological barrier of the new player joining the group is lowered, and thus, the group is easily formed.

(Appendix 4)

The information processing apparatus according to appendix 3, in which the join control unit displays the information about the betting information indicating that the players in the group bets on the predetermined screen where the other players perform operations for joining the group.

According to (Appendix 4), it is possible to provide information about bets already betted by the players in the group to the player who is to newly join the group. Accordingly, the player easily selects the desired group with reference to the betting information of the participants of the group.

(Appendix 5)

The information processing apparatus according to appendix 4, in which
the benefit assigning unit determines the first benefit based on the benefit grade information according to the total betting amounts of the first value betted by the players in the group and the first betting information, and
the join control unit allows the predetermined screen to display the benefit grade information according to the total betting amount of the first value betted by the players in the group when the predetermined screen is displayed.

According to (Appendix 5), it is possible to provide the information about the benefit obtained by joining the group to the player intending to newly join the group before joining the group. Accordingly, the player can easily join the group in which the benefit of the grade desired by the player is likely to be obtained.

(Appendix 6)

The information processing apparatus according to appendix 5, in which the join control unit allows the predetermined screen to display, together with the benefit grade information at the timing, information about the first value betting amount required to upgrade the benefit grade information at the timing.

According to (Appendix 6), information about the benefit that can be obtained by joining the group and information about the betting amount required to further upgrade the benefit can be provided to the players newly joining the group before joining. Accordingly, the player can easily join the group in which the benefit of the grade desired by the player is likely to be obtained.

(Appendix 7)

The information processing apparatus according to any one of appendices 1 to 6, in which
the reception unit can receive betting information designating at least one of the first value or the second value from each of the plurality of players for the game, and
the benefit assigning unit determines the first benefit based on the benefit grade information according to the total betting amounts of the first value betted by the players joining the group and the first betting information.

According to (Appendix 7), since the first benefit assigned to the first player can be changed according to the betting which designates the first value of the players in the group, it is possible to provide the motivation to perform the betting which designates the first value to the players in the group.

(Appendix 8)

The information processing apparatus according to appendix 7, in which, when the second betting information designates the first value, the benefit assigning unit assigns the first benefit to the second player regardless of whether the first betting information designates the first value or the second value.

According to (Appendix 8), when the player in the group bets by designating the first value, since the assigned benefit can be obtained by betting of other players in the group, it is possible to encourage the players in the group to perform the betting with the first value.

(Appendix 9)

The information processing apparatus according to appendix 7 or 8, in which, when only the second value is designated in the second betting information, the benefit assigning unit assigns the first benefit to the second value when the first betting information designates the second value.

According to (Appendix 9), when the player in the group performs the betting which designates only the second value, other players in the group is assigned with only the benefit receivable by the betting designating the second value. Therefore, it is possible to encourage the players in the group to perform the betting by designating not only the second value but also the first value.

(Appendix 10)

The information processing apparatus according to any one of appendices 1 to 9, in which
the benefit assigning unit determines the amount of the first benefit to be assigned to the first player with a probability according to rank information set based on betting history for the first player, and
when the second betting information satisfies the predetermined condition, the determined amount of the first benefit is assigned to the second player.

According to (Appendix 10), it is possible to change the amount of the first benefit assigned to the first player based on a rank of the first player set based on the betting history. Accordingly, it is possible to change the amount of the benefit that other players can obtain according to ranks of the players in the group.

(Appendix 11)

The information processing apparatus according to any one of appendices 1 to 10, in which
when the total betting amounts of the first value of the players in the group satisfies a first condition, the benefit assigning unit draws lottery to determine whether to assign the third benefit to the group, and
when assigning the third benefit to the group, the benefit assigning unit assigns the third benefit to the player betting by designating the first value among the players in the group.

According to (Appendix 11), according to the total betting amounts designating the first value by the players in the group, the benefit can be assigned to the players having betted with the first value among the players in the group. Accordingly, it is possible to encourage the players in the group to perform the betting by designating the first value.

(Appendix 12)

An information processing method for receiving bets on a result of a game, the method including:
a registration process in which a computer registers a plurality of players including a first player and a second player as a group;
a reception process in which the computer receives first betting information indicating that the first player bets and the second betting information indicating that the second player bets for the game; and
a benefit assigning process in which the computer assigns the first benefit determined based on the first betting information to the first player, in which
in the benefit assigning process, the computer assigns the first benefit to the second player when the second betting information satisfies a predetermined condition.

(Appendix 13)

A program for causing a computer receiving bets on a result of a game to function as:
a registration unit registering a plurality of players including a first player and a second player as a group;
a reception unit receiving first betting information indicating that the first player bets and second betting information indicating that the second player bets for the game; and
a benefit assigning unit assigning a first benefit determined based on the first betting information to the first player, in which
the benefit assigning unit assigns the first benefit to the second player when the second betting information satisfies a predetermined condition.

The foregoing example implementation may have various benefits and advantages. For example, example implementations provide benefit assignments that enhance players' motivations in bet placement. Additionally, through provision of benefits based on the specialized interactions and processes between the server and the terminals as disclosed above, players are incentivized to induce other players into joining the bets through game initiations.

### REFERENCE SIGNS LIST

1: betting system
10: server
11: processor
12: storage device
13: communication interface
14: input device
15: output device
20: terminal
20A: terminal
20B: terminal
100: storage unit
101: display control unit
102: reception unit
103: betting process unit
104: benefit assigning unit
105: payment process unit
110: join control unit
111: registration unit
500: betting screen
501: button
502: betting amount information display area
503: betting ticket information display area
510: recruitment screen
511: host player information display area
512: number-of-joinable-player display area
513: betting information display area
514: cancel button
515: confirmation button
520: join request screen
521: group list display area
521A: first group display area
521B: second group display area
522A: join button
522B: join button
530: team play screen
531: member screen tab
532: timeline screen tab
533: member information display area
533A: first member display area
533B: second member display area
534: purchased ticket display button
536: betting information display area
540: member display area
541: benefit grade display area
542: timeline display area
542A: first message
542B: second message
542C: third message
542D: fourth message
550: purchased betting ticket details screen
551: betting ticket information display area
553: copy bet button
560: benefit assignment screen
561: benefit information display area
561A: first player benefit display area
561B: second player benefit display area
561C: third player benefit display area
561D: fourth player benefit display area
562: assigned benefit display area
T1: benefit grade information table

1. A computer-implemented method for processing information, the method comprising:
at a terminal, providing a prompt in a display for a user to enter a target and a value associated with an online contest;
at the terminal, receiving an input in response to the prompt, input including the target and the value;
during a predetermined time window, receiving an instruction to join a group in the display of the terminal, wherein the group comprises a plurality of other terminals remote from the terminal and from one another, each of the terminals associated with respective different users, wherein the plurality of other terminals and their respective different users are prompted to provide group joining information in a standardized user interface;
for the instruction indicating that the user is associated with the group, and for a predetermined condition being met, automatically providing the user with a benefit;
at an end of the predetermined time window, retrieving a result of the online contest and comparing the results of the online contest to the target and the value of the user to provide, in real time, a reward when the comparing determines a match between the results of the online contest and the target and the value of the user; and
displaying to the user a result of the online contest, a calculation basis of the benefit of the user, and respective benefits of the plurality of terminals and the different users associated with each of the plurality of terminals, wherein the displaying to the user and the different users is performed substantially simultaneously,
wherein the benefit is calculated based on a degree of contribution of the user and each of the different users associated with each of the plurality of terminals, with respects to the online contest.

2. The computer-implemented method of claim 1, wherein the value has a monetary component and a nonmonetary component.

3. The computer-implemented method of claim 1, wherein the predetermined time window comprises a starting point at an opening of the online contest, and an ending point of an end of a competition associated with the online contest.

4. The computer-implemented method of claim 3, the user and the different users remain in the group until the ending point.

5. The computer-implemented method of claim 4, the user and the different users do not join another group until the ending point.

6. The computer-implemented method of claim 1, wherein the benefit of the user and the different users is determined based on a level of the user.

7. The computer-implemented method of claim 6, wherein the benefit comprises an individual component that is unique to each of the user and each of the different users, and a group component that is common to the user and each of the different users in the group.

8. The computer-implemented method of claim 7, wherein the benefit associated with the individual component is determined as a percent return rate multiplied by the value of a nonmonetary element.

9. The computer-implemented method of claim 8, wherein the individual component is determined based on a degree of contribution that is set by dividing an amount of rewards to be pay into predetermined classifications based on the levels, and setting a plurality of levels based on a degree of proficiency in the online contest that varies over the predetermined time window, and is updated on a periodic basis or when a predetermined condition is satisfied.

10. The computer-implemented method of claim 9, wherein the benefit is assigned according to a highest level amongst the levels in the group.

11. A computer-implemented method for processing information between a first terminal and a second terminal remote to the first terminal via a remote server, the method comprising:
in a first display associated with the first terminal, receiving first betting information associated with an online contest from a first user and providing a signal associated with the first betting information to the remote server;
at the remote server, applying the received first betting information to a betting process to generate a result, and providing the generated result of the betting process to the first terminal;
at the first terminal, providing the received results to a first user via the first display, wherein the receive result is indicative of an accepted bet, providing the first user with a prompt in a portion of the display to remotely recruit one or more additional users to join a team, and receiving a team player input from the first user indicative of a request to post and remotely recruit the team;
at the second terminal, receiving a request from a second user to provide a standardized team play list, providing the request for the standardized team play list to the remote server;
at the remote server, in response to the received request from the second terminal, providing a standardized team play list to the second terminal to be displayed on a display as a standardized user interface;
at the second terminal receiving a standardized joint request from the second user by way of a prompt in an interface of the display, and providing the received standardized join requests to the remote server;
at the remote server, providing a notification to the first terminal and the second terminal indicative of the first user and the second user being joined in the team, wherein the first terminal and the second terminal each display and enter place on the displays of the first and second terminals of a team play screen;
at the second terminal, receiving second betting information associated with the second user and with the online contest by way of a prompt in a region of the display of the second terminal, and providing the received second betting information to the remote server;
at the remote server, executing the betting process for the second betting information, and providing a confirmation to the second terminal, and updating and providing a notification of timeline information to the first terminal and second terminal;
at the remote server, once the team is confirmed and a betting deadline has passed, providing a team confirmation notification to the first terminal and the second terminal, and once the online contest results is confirmed, determining a hit result for the first user and second user;
at the remote server, determining a benefit;
at the remote server, providing a signal to the first terminal and to the second terminal to display an assignment of the benefit; and
at the first terminal and the second terminal, displaying, in the first display and second display of the respective first terminal and second terminal, and assignment of the benefit, wherein the first display and the second display are provided in a standardized format.

12. The computer-implemented method of claim 11, wherein the first betting information and the second betting information has a monetary component and a nonmonetary component.

13. The computer-implemented method of claim 11, wherein a predetermined time window comprises a starting point at an opening of the online contest, and an ending point of an end of a competition associated with the online contest.

14. The computer-implemented method of claim 13, the user and the additional users remain in the team until the ending point.

15. The computer-implemented method of claim 14, the user and the additional users do not join another team until the ending point.

16. The computer-implemented method of claim 11, wherein the benefit of the user and the additional users is determined based on a level of the user.

17. The computer-implemented method of claim 16, wherein the benefit comprises an individual component that is unique to each of the user and each of the additional users, and a team component that is common to the user and each of the additional users in the team.

18. The computer-implemented method of claim 17, wherein the benefit associated with the individual component is determined as a percent return rate multiplied by a value of a nonmonetary element.

19. The computer-implemented method of claim 18, wherein the individual component is determined based on a degree of contribution that is set by dividing an amount of rewards to be pay into predetermined classifications based on the levels, and setting a plurality of levels based on a degree of proficiency in the online contest that varies over a predetermined time window, and is updated on a periodic basis or when a predetermined condition is satisfied.

20. The computer-implemented method of claim 19, wherein the benefit is assigned according to a highest level amongst the levels in the team.

21. The computer-implemented method of claim 19, further comprising a betting screen that displays betting information generated on the terminal, wherein the betting screen includes a user input section for recruiting joining the group, a betting amount information display area for displaying information about the betting amount betted for a target race by the player and a total of the amounts of the first value and the second value aggregated, and a betting ticket information display area for displaying information of the betting ticket that the player betted for the target race, such that when the terminal receives a user input and senses or detects that the user input section is activated, the terminal transmits a signal to notify the server of recruiting the members for team play, and when the server a signal associated with a team play recruitment request from the terminal, the server registers the team play information including information about the host player and the target race based on the received information, and further wherein when the terminal receives the team play recruitment request based on the user input, the server generates a signal for the terminal to display a recruitment screen.

22. The computer-implemented method of claim 19, wherein the recruitment screen includes a host player information display area, a number-of-joinable-player display area, a betting information display area, a cancel button, and a confirmation button, and wherein the recruitment screen corresponds to recruitment request information generated and displayed on the terminal, the host player information display area of terminal displays the information of the players who are recruiting for the group is displayed and a total of each of the first value and the second value designated with a betting ticket with which the player bets with, the number-of-joinable-player display area of the terminal displays information about players in the group as the guest players, and in the betting information display area of the terminal, displayed are the total first value betted for the target race by all players currently in the group, the information about the benefit grade achieved by the total first value, and the information about the betting amount required to upgrade to the next benefit grade.

23. The computer-implemented method of claim 19, where a join request screen of terminal includes a group list display area for displaying the list of groups matching the condition requested by the player, the group list display area including a first group display area and a second group display area, wherein the first group display area displays the information about the group of the player as the first group and the total betting amounts of the first value and the second value of the players in the first group, the information about the benefit grade, and information required to upgrade the benefit grade to be referenced, and the second group display area displays the information about the group of the player as the second group and the total betting amounts of the first value and the second value of the players in the second group, the information about the benefit grade, and information required to upgrade the benefit grade, wherein the terminal generates and transmits a signal to requests the server to join the selected group, the server receives a join request from the terminal and when the target group is enabled to join, the server allows the player to join the group and notifies the terminals that the player joins the group.

24. The computer-implemented method of claim 19, wherein the team play screen includes a member screen tab and a timeline screen tab, wherein the member screen tab is an area for displaying information about the players in the group and a member information display area, and the member information display area includes a first member display area, a second member display area, and a betting information display area, and further wherein the first member display area of terminal confirms the information of the betting ticket purchased by the player displayed in the member display area by including the information about the host player and the information about the total betting amounts of the first value and the second value betted by the host player and by selecting a purchased race-ticket display button, the second member display area of terminal is information about the first guest player, wherein in the betting information display area, displayed are the total first value betted for the target race by all the players currently in the group, the information about the benefit grade achieved by the total first value, and the information about the betting amount required to upgrade to the next benefit grade, and the timeline screen tab displays the history of operations of the players in the group.

25. The computer-implemented method of claim 19, wherein a benefit assignment screen is displayed on the display of the terminal and includes a benefit information display area and an assigned benefit display area, wherein the benefit information display area of terminal includes a first player benefit display area for displaying the benefit determined based on the betting information of the first player, a second player benefit display area for displaying the benefit determined based on the betting information of the second player, a third player benefit display area for displaying the benefit determined based on the betting information of the third player, and a fourth player benefit display area for displaying the benefit determined based on the betting information of the fourth player, and wherein the assigned benefit display area displays a total of the benefits assigned to the player including the benefit information of the other players in the group for the player A who is the first player, and wherein the plurality of players form the group and bet for the race, and by obtaining the benefit based on the betting information of other players in the group, more advantageous benefit than the of not forming the group is easily obtained due to the interaction of the server and terminals to provide a sequence of operations and displays that permits players to be able to form a group, and to be able to bet on the race, based on the betting information of other players in the group, in a manner that provides an incentive to forming the group.

26. The computer-implemented method of claim 11, wherein the calculation of the benefit is based on an aggregation of the total betting amount of the team, and a benefit grade is assigned such that a chance of a great hit, it, medium hit or no hit is associated with the benefit grade.

27. The computer-implemented method of claim 11, wherein for each of the players in the team, information is received on the player level and betting information for both monetary and nonmonetary components, and based on whether there is a hit or no hit, and the benefit grade, as well as a number of privileges, a benefit is assigned for each player, and a total benefit is calculated for the team.

28. The computer-implemented method of claim 27, wherein the calculation of the benefit is based on a hit condition for the monetary component of the bet comprising a hit box.

29. The computer-implemented method of claim 27, wherein the calculation of the benefit is based on a no hit condition for the monetary component of the bet comprising a no hit box.

30. The computer-implemented method of claim 27, where the calculation of the benefit is based on a hit condition for the nonmonetary component of the bet comprising a hit bag.

31. The computer-implemented method of claim 27, where the calculation of the benefit is based on a no hit condition for the nonmonetary component of the bet comprising a no hit bag.
